(19) United States
(12) Patent Application Publication
(10) Pub. No.: US 2008/0235300 A1
(43) Pub. Date: Sep. 25, 2008

(54) DATA MIGRATION PROCESSING DEVICE

(76) Inventors: Jun Nemoto, Yokohama (JP); Takaki Nakamura, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/972,657

(22) Filed: Jan. 11, 2008

(30) Foreign Application Priority Data
Mar. 23, 2007 (JP) 2007-076882

(51) Int. Cl. G06F 17/00

(52) U.S. Cl. 707/204; 707/E17.005

(57) ABSTRACT

A migration target comprising one or more objects is migrated to a migration-destination file server, which is the file server specified as the migration destination, and object correspondence management information, which is information showing the corresponding relationship between respective migration-source object IDs for identifying in a migration source respective objects included in the migration target, and respective migration-destination object IDs for identifying these respective objects in the migration-destination file server, is created in the migration-destination file server.

### CROSS-REFERENCE TO PRIOR APPLICATION

This application relates to and claims the benefit of priority from Japanese Patent Application number 2007-76882, filed on Mar. 23, 2007, the entire disclosure of which is incorporated herein by reference.

### BACKGROUND

The present invention generally relates to technology for data migration between file servers.

A file server is an information processing apparatus, which generally provides file services to a client via a communications network. A file server must be operationally managed so that a user can make smooth use of the file services. The migration of data can be cited as one important aspect in the operational management of a file server. When the load intensifies on a portion of the file servers of a plurality of file servers, or when the storage capacities of a portion of the file servers of a plurality of file servers are about to reach their upper limits, migrating data to another file server makes it possible to distribute the load and ensure storage capacity.

Methods for carrying out data migration between file servers include a method, which utilizes a device (hereinafter, root node) for relaying communications between a client and a file server (for example, the method disclosed in Japanese Patent Laid-open No. 2003-203029). Hereinbelow, the root node disclosed in Japanese Patent Laid-open No. 2003-203029 will be called a “conventional root node”.

A conventional root node has functions for consolidating the exported directories of a plurality of file servers and constructing a pseudo file system, and can receive file access requests from a plurality of clients. Upon receiving a file access request from a certain client for a certain object (file), the conventional root node executes processing for transferring this file access request to the file server in which this object resides by converting this file access request to a format that this file server can comprehend.

Further, when carrying out data migration between file servers, the conventional root node first copies the exported directory of either file server to the other file server while maintaining the directory structure of the pseudo file system as-is. Next, the conventional root node keeps the data migration concealed from the client by changing the mapping of the directory structure of the pseudo file system, thereby enabling post-migration file access via the same namespace as prior to migration.

When a client makes a request to a file server for file access to a desired object, generally speaking, an identifier called an object ID is used to identify this object. For example, in the case of the file sharing protocol NFS (Network File System), an object ID called a file handle is used.

Because an object ID is created in accordance with file server-defined rules, the object ID itself will change when data is migrated between file servers (that is, the object ID assigned to the same object by a migration-source file server and a migration-destination file server will differ.). Thus, the client is not able to access this object if it request file access to the desired object using the pre-migration object ID (hereinafter, migration-source object ID).

Therefore, it is necessary manage the pre-migration and post-migration object IDs, and to conceal the data migration from the client so that trouble does not occur in the client due to the change of the object ID. The conventional root node maintains a table, which registers the corresponding relationship between the migration-source object ID in the migration-source file server and the post-migration object ID in the migration-destination file server (hereinafter, migration-destination object ID). Then, upon receiving a file access request with the migration-source object ID from the client, the conventional root node transfers the file access request to the appropriate file server after rewriting the migration-source object ID to the migration-destination object ID by referencing the above-mentioned table.

The conventional root node executes both processing for transferring request data from the client (hereinafter, may be called “request transfer processing”) and processing for tracking the corresponding relationship of the object IDs (hereinafter, may be called “object search processing”). Thus, when the number of file servers increases and load balancing is carried out among the file servers, the number of objects to be managed also increases as a result of the increase in the number of file servers, making the load of object search processing that much greater. Consequently, request transfer processing performance deteriorates, resulting in the conventional root node becoming a bottleneck, and overall system performance (response to the client) decreasing.

Further, for example, when replacing a first file server with a second file server, an object managed by the first file server is generally migrated to the second file server, and the second file server receives a file access requests in place of the first file server. The client issues a file access request using the migration-source object ID.

### SUMMARY

Therefore, a first object of the present invention is to reduce the processing load of a root node, which receives a file access request.

A second object of the present invention is to enable a migration-destination file server to support a migration target object with a migration-source object ID.

Other objects of the present invention should become clear from the following explanation.

To solve for these problems, object correspondence management information is created in the migration-destination file server. More specifically, when a migration target comprising one or more objects is migrated to a migration-destination file server, which has been specified as the migration destination, object correspondence management information is created in the migration-destination file server as information, which denotes the corresponding relationship between the respective migration-source object IDs for identifying in the migration source the respective objects comprising the migration target, and the respective migration-destination object IDs for identifying these respective objects in the above-mentioned migration-destination file server.

Upon receiving request data having a migration-source object ID, if this request data is to be transferred to a migration-destination file server, a root node can specify a migration-destination object ID corresponding to this migration-source object ID by analyzing the object correspondence management information in the migration-destination file server. If this kind of analysis cannot be carried out in the migration-destination file server, the root node can use the migration-source object ID to issue a query, thereby enabling the migration-destination file server to respond to this query, and reply to the root node with the migration-destination object ID. The root node can then transfer request data comprising this migration-destination object ID to the migration-destination file server.

Further, since object correspondence management information is created in the migration-destination file server when the migration-destination file server is specified for the purpose of replacement, it is possible to support request data comprising a migration-source object ID. Furthermore, a migration-source object ID can be included in the respective objects, which are managed in the file system of the migration-destination file server, and which constitute a migration target.

### BRIEF DESCRIPTION OF THE DRAWINGS

FIG. 1 is a diagram showing an example of the constitution of a computer system comprising a root node related to a first embodiment of the present invention;

FIG. 2 is a block diagram showing an example of the constitution of a root node;

FIG. 3 is a block diagram showing an example of the constitution of a leaf node;

FIG. 4 is a block diagram showing a parent configuration information management program;

FIG. 5 is a block diagram showing an example of the constitution of a child configuration information management program;

FIG. 6 is a block diagram showing an example of the constitution of a switching program;

FIG. 7 is a block diagram showing an example of the constitution of file access management module;

FIG. 8 is a diagram showing an example of the constitution of a switching information management table;

FIG. 9 is a diagram showing an example of the constitution of a server information management table;

FIG. 10 is a diagram showing an example of the constitution of an algorithm information management table;

FIG. 11 is a diagram showing an example of the constitution of a connection point management table;

FIG. 12 is a diagram showing an example of the constitution of a GNS configuration information table;

FIG. 13A is a diagram showing an example of an object ID exchanged in the case of an extended format OK;

FIG. 13B (a) is a diagram showing an example of an object ID exchanged between a client and a root node, and between a root node and a root node in the case of an extended format NG;

FIG. 13B (b) is a diagram showing an example of an object ID exchanged between a root node and a leaf node in the case of an extended format NG;

FIG. 14 is a flowchart of processing in which a root node provides a GNS;

FIG. 15 is a flowchart of processing (response processing) when a root node receives response data;

FIG. 16 is a flowchart of GNS local processing executed by a root node;

FIG. 17 is a flowchart of connection point processing executed by a root node;

FIG. 18 is a diagram showing examples of the constitutions of a migration-source file system 501 and a migration-destination file system 500;

FIG. 19 is a diagram showing an example of a migration status management table in the first embodiment;

FIG. 20 is a diagram showing an example in which a leaf node file system is migrated to a root node while maintaining the directory structure of the pseudo file system as-is;

FIG. 21 is a flowchart of data migration processing in the first embodiment;

FIG. 22 is a flowchart of processing executed by a root node in response to receiving request data from a client in the first embodiment;

FIG. 23 is a diagram showing an example of the constitution of a switching program in a root node of a second embodiment of the present invention;

FIG. 24 is a flowchart of processing executed by a root node in response to receiving request data from a client in the second embodiment;

FIG. 25 is a diagram showing an example of the constitution of a switching program in a root node of a third embodiment of the present invention;

FIG. 26 is a diagram showing an example of the constitution of a client connection information management module;

FIG. 27 is a diagram showing an example of the constitution of a client connection information management table;

FIG. 28 is a diagram showing an example of the constitution of a migration processing status management table in the third embodiment;

FIG. 29 is a flowchart of data migration processing in the third embodiment; and

FIG. 30 is a flowchart of entry/index deletion processing.

### DETAILED DESCRIPTION OF THE PREFERRED EMBODIMENTS

In one embodiment, a data migration processing device comprises a migration target migration module; and a correspondence management indication module. The migration target migration module can migrate a migration target comprising one or more objects to a migration-destination file server, which is the file server specified as the migration destination. The correspondence management indication module can send to the migration-destination file server a correspondence management indication for creating object correspondence management information. Object correspondence management information is information, which denotes the corresponding relationship between the respective migration-source object IDs for identifying in the migration source the respective objects comprised in a migration target, and the respective migration-destination objects IDs for identifying these respective objects in the above-mentioned migration-destination file server.

The migration target can be treated as a share unit, which is a logical public unit, and which has one or more objects. Further, the data migration processing device can be a migration-source file server, or a root node. This root node can support file-level virtualization feature for providing a plurality of share units to the client as a single pseudo file system (virtual namespace).

In one embodiment, the migration target is a first directory tree denoting the hierarchical relationship of a plurality of objects. Object correspondence management information is a second directory tree having a plurality of link files, which are associated to the plurality of objects in the first directory tree. For example, when the migration target is a share unit, the correspondence management indication module can indicate the creation of a specified directory in a specified location of a file system managed by the migration-destination file server, acquire the migration-source object ID of the object in the share unit, and indicate the positioning of a link file, which has the migration-source object ID as a file name, under a specified directory. In this case, the second directory tree becomes the directory tree, which has the specified directory as its top directory. The correspondence management indication module can acquire and manage an object ID of this specified directory.

In one embodiment, the data migration processing device can further comprise a migration management module, which registers in migration management information migration target information showing a migration target, and migration-destination information denoting the migration-destination file server; a request data receiving module, which receives request data having a migration-source object ID; and a request transfer processing module, which uses information in the migration-source object ID to specify from the migration management information migration-destination information corresponding to this migration-source object ID, and transfers request data having the migration-source object ID to the migration-destination file server denoted by the specified migration-destination information.

In one embodiment, the data migration processing device can further have a request transfer processing module. This request transfer processing module can use the migration-source object ID and object ID of the specified directory to issue an object ID query to the migration-destination file server designated by the specified migration-destination information. The request transfer processing module can change the migration-source object ID of the request data to a migration-destination object ID obtained from a response receiving from the migration-destination file server in response to this query, and can transfer the request data having the migration-destination object ID to the migration-destination file server. The request transfer processing module can execute processing like this, for example, when it is specified, based on the specified migration-destination information, that the migration-destination file server, which is specified from this migration-destination information, does not have an index processing function (a function, which analyzes the object correspondence management information and looks up a migration-destination object ID corresponding to the migration-source object ID). Further, upon making the migration-source object ID used in the query correspondent in the cache area to a migration-destination object ID obtained in response to this query and receiving request data, if a migration-destination object ID corresponding to the migration-source object ID in this request data is detected in the cache area, the request transfer processing module can transfer to the migration-destination file server request data, which has this migration-destination object ID instead of the migration-source object ID. Further, the request transfer processing module can issue the above-mentioned query when this migration-destination object ID is not detected in the cache area.

In one embodiment, the data migration processing device can comprise a delete indication module. The delete indication module can indicate to the above-mentioned migration-destination file server a delete indication for deleting object correspondence management information when a migration-source object ID is not used for the respective objects of the above-mentioned migration target. A migration-source object ID is not used for the objects of a migration target when it is detected that the migration target has been unmounted from all the clients. More specifically, for example, it is a case in which the pseudo file system has been unmounted from all the clients that make use of this pseudo file system. Further, either instead of or in addition to this, the delete indication module can indicate a delete indication to the above-mentioned migration-destination file server to delete the object correspondence management information when there has been no access from any client following the passage of a prescribed period of time after the end of the migration of a migration target. The migration-destination file server can delete object correspondence management information in response to such a delete indication.

In one embodiment, the data migration processing device can further comprise a request data receiving module, which receives request data having a migration-source object ID; a determination module, which makes a determination as to whether or not an object corresponding to the migration-source object ID of this request data is an object in the above-mentioned migration target, and if this migration target is in the process of being migrated; and a response processing module, which, if the result of the determination is affirmative, creates response data which denotes that it is not possible to access the object corresponding to the above-mentioned migration-source object ID (for example, a JUKEBOX error), and sends this response data to the source of this request data. The data migration processing device can suspend all access when a migration target is undergoing migration of one sort or another (for example, return response data which denotes that access is not always possible when a file access request is received), or can suspend access only when a file access request is received for an object comprised in a migration target.

In one embodiment, the migration-destination file server can comprise a correspondence manage indication receiver for receiving the above-mentioned correspondence manage indication; a correspondence management creation module that creates object correspondence management information in response to this correspondence manage indication; a migration-destination object ID specification module (that is, the above-mentioned index processing function), which receives request data comprising a migration-source object ID, and specifies a migration-destination object ID corresponding to this migration-source object ID by analyzing the object correspondence management information; and a request data processing module, which executes an operation in accordance with this request data for an object identified from the migration-destination object ID.

In one embodiment, for example a file system is migrated as a share unit to the migration-destination file server from the migration source. In addition to a directory tree denoting the migrated share unit, a directory tree constituting the index therefor (hereinafter, index directory tree) is prepared in the migration-destination file system. The index directory tree can be constituted from a link to a migration-destination file, which uses the migration-source object ID as the file name. Link as used here is a file, which points to a migration-destination object (for example, a file). For example, this link can be a hard link or a symbolic link.

The migration-source object ID, for example, comprises share information, which is information designating a share unit (for example, a share ID for identifying a share unit). Further, a migration status management table is prepared. First, the migration management module, for example, can register migration-source share information corresponding to this migration target in this table when migrating a migration target, and when this migration ends, can make this migration-destination share information correspond to this migration-source share information. Thus, by referencing the table, it is possible to determine whether a certain share unit has yet to be migrated, is in the process of being migrated, or has already been migrated.

The request data receiving module of the data migration processing device can receive from the client a file access request having a migration-source object ID comprising share information. The request transfer processing module can acquire share information from this migration-source object ID, and by using this share information to reference the migration status management table, can determine whether the share unit denoted by this share information has yet to be migrated, is in the process of being migrated, or has already been migrated. When the share unit has yet to be migrated, the request transfer processing module can transfer a file access request to the file server managing this share unit, and respond to the client with the result. When the share unit is in the process of being migrated, the request transfer processing module can suspend client access (For example, the request transfer processing module can issue a notification that services have been temporarily cancelled.). When the share unit has already been migrated, the request transfer processing module can ascertain whether or not the migration-destination file system is a local file system, and if it is a local file system, can access the file entity by using the migration-source object ID to track the index directory tree, and can respond to the client with the result.

If the migration-destination file system is in a remote migration-destination file server, the request transfer processing module can ascertain whether or not this migration-destination file server is equipped with an index processing function. If this migration-destination file server is equipped with an index processing function, the request transfer processing module can transfer a file access request from the client to the migration-destination file server as-is, and can respond to the client once the result comes back. If this migration-destination file server is not equipped with an index processing function, the request transfer processing module can use the object ID of the index directory and the migration-source object ID to access the link file, and by tracking this link, can acquire the migration-destination object ID. Then, the request transfer processing module can transfer a file access request having the acquired object ID to the migration-destination file server, and can respond to the client with the result.

Any two or more of the plurality of embodiments described above may be combined. At least one of all of the modules (migration target migration module, correspondence management indication module, migration management module, request data receiving module, request transfer processing module, and so forth) can be constructed from hardware, computer programs, or a combination thereof (for example, some can be implemented via computer programs, and the remainder can be implemented using hardware). A computer program is read in and executed by a prescribed processor. Further, when a computer program is read into a processor and information processing is executed, a storage region that resides in memory or some other such hardware resource can also be used. Further, a computer program can be installed in a computer from a CD-ROM or other such recording medium, or it can be downloaded to a computer via a communications network.

A number of embodiments of the present invention will be explained in detail hereinbelow by referring to the figures.

### First Embodiment

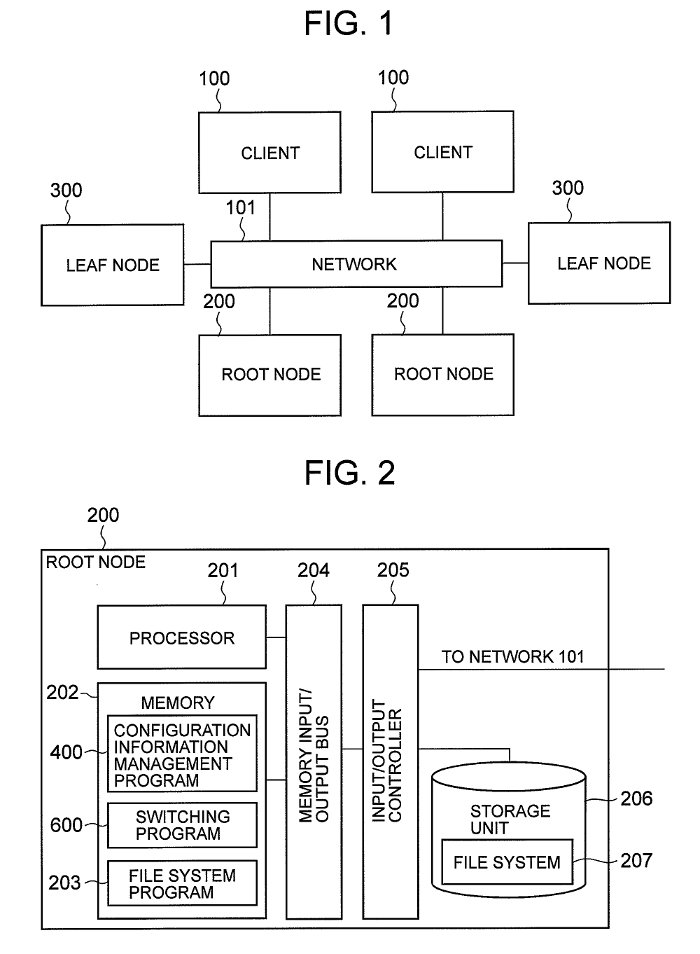

FIG. 1 is a diagram showing an example of the constitution of a computer system comprising a root node related to a first embodiment of the present invention.

At least one client 100, at least one root node 200, and at least one leaf node 300 are connected to a communications network (for example, a LAN (Local Area Network)) 101. The leaf node 300 can be omitted altogether.

The leaf node 300 is a file server, which provides the client 100 with file services, such as file creation and deletion, file reading and writing, and file movement.

The client 100 is a device, which utilizes the file services provided by either the leaf node 300 or the root node 200.

The root node 200 is located midway between the client 100 and the leaf node 300, and relays a request from the client 100 to the leaf node 300, and relays a response from the leaf node 300 to the client 100. A request from the client 100 to either the root node 200 or the leaf node 300 is a message signal for requesting some sort of processing (for example, the acquisition of a file or directory object, or the like), and a response from the root node 200 or the leaf node 300 to the client 100 is a message signal for responding to a request. Furthermore, the root node 200 can be logically positioned between the client 100 and the leaf node 300 so as to relay communications therebetween. The client 100, root node 200 and leaf node 300 are connected to the same communications network 101, but logically, the root node 200 is arranged between the client 100 and the leaf node 300, and relays communications between the client 100 and the leaf node 300.

The root node 200 not only possesses request and response relay functions, but is also equipped with file server functions for providing file service to the client 100. The root node 200 constructs a virtual namespace when providing file services, and provides this virtual namespace to the client 100. A virtual namespace consolidates all or a portion of the sharable file systems of a plurality of root nodes 200 and leaf nodes 300, and is considered a single pseudo file system. More specifically, for example, when one part (X) of a file system (directory tree) managed by a certain root node 200 or leaf node 300 is sharable with a part (Y) of a file system (directory tree) managed by another root node 200 or leaf node 300, the root node 200 can construct a single pseudo file system (directory tree) comprising X and Y, and can provide this pseudo file system to the client 100. In this case, the single pseudo file system (directory tree) comprising X and Y is a virtualized namespace. A virtualized namespace is generally called a GNS (global namespace). Thus, in the following explanation, a virtualized namespace may be called a “GNS”. Conversely, a file system respectively managed by the root node 200 and the leaf node 300 may be called a “local file system”. In particular, for example, for the root node 200, a local file system managed by this root node 200 may be called “own local file system”, and a local file system managed by another root node 200 or a leaf node 300 may be called “other local file system”.

Further, in the following explanation, a sharable part (X and Y in the above example), which is either all or a part of a local file system, that is, the logical public unit of a local file system, may be called a “share unit”. In this embodiment, a share ID, which is an identifier for identifying a share unit, is allocated to each share unit, and the root node 200 can use a share ID to transfer a file access request from the client 100. A share unit comprises one or more objects (for example, a directory or file).

Further, in this embodiment, one of a plurality of root nodes 200 can control the other root nodes 200. Hereinafter, this one root node 200 is called the “parent root node 200p”, and a root node 200 controlled by the parent root node is called a “child root node 200c”. This parent-child relationship is determined by a variety of methods. For example, the root node 200 that is initially booted up can be determined to be the parent root node 200p, and a root node 200 that is booted up thereafter can be determined to be a child root node 200c. A parent root node 200p, for example, can also be called a master root node or a server root node, and a child root node 200c, for example, can also be called a slave root node or a client root node.

FIG. 2 is a block diagram showing an example of the constitution of a root node 200.

A root node 200 comprises at least one processor (for example, a CPU) 201; a memory 202; a memory input/output bus 204, which is a bus for input/output to/from the memory 202; an input/output controller 205, which controls input/output to/from the memory 202, a storage unit 206, and the communications network 101; and a storage unit 206. The memory 202, for example, stores a configuration information management program 400, a switching program 600, and a file system program 203 as computer programs to be executed by the processor 201. The storage unit 206 can be a logical storage unit (a logical volume), which is formed based on the storage space of one or more physical storage units (for example, a hard disk or flash memory), or a physical storage unit. The storage unit 206 comprises at least one file system 207, which manages files and other such data. A file can be stored in the file system 207, or a file can be read out from the file system 207 by the processor 201 executing the file system program 203. Hereinafter, when a computer program is the subject, it actually means that processing is being executed by the processor, which executes this computer program.

The configuration information management program 400 is constituted so as to enable the root node 200 to behave either like a parent root node 200p or a child root node 200c. Hereinafter, the configuration information management program 400 will be notated as the “parent configuration information management program 400p” when the root node 200 behaves like a parent root node 200p, and will be notated as the “child configuration information management program 400c” when the root node 200 behaves like a child root node 200c. The configuration information management program 400 can also be constituted such that the root node 200 only behaves like either a parent root node 200p or a child root node 200c. The configuration information management program 400 and switching program 600 will be explained in detail hereinbelow.

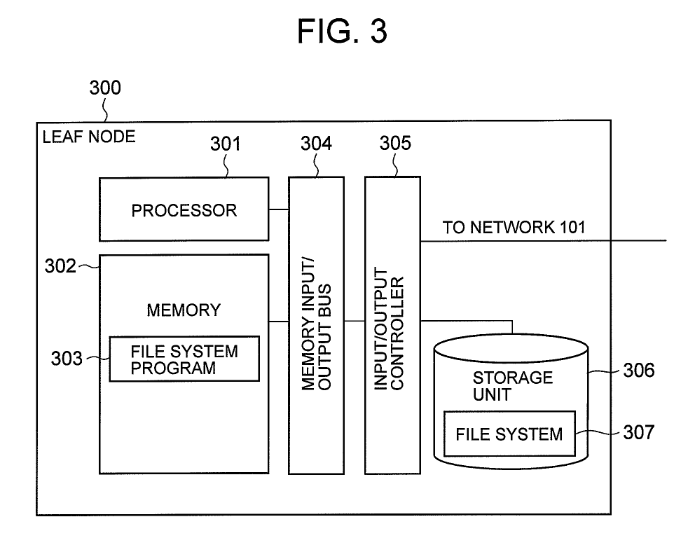

FIG. 3 is a block diagram showing an example of the constitution of a leaf node 300.

A leaf node 300 comprises at least one processor 301; a memory 302; a memory input/output bus 304; an input/output controller 305; and a storage unit 306. The memory 302 comprises a file system program 303. Although not described in this figure, the memory 302 can further comprise a configuration information management program 400. The storage unit 306 stores a file system 307.

Since these components are basically the same as the components of the same names in the root node 200, explanations thereof will be omitted. Furthermore, the storage unit 306 can also exist outside of the leaf node 300. That is, the leaf node 300, which has a processor 301, can be separate from the storage unit 306.

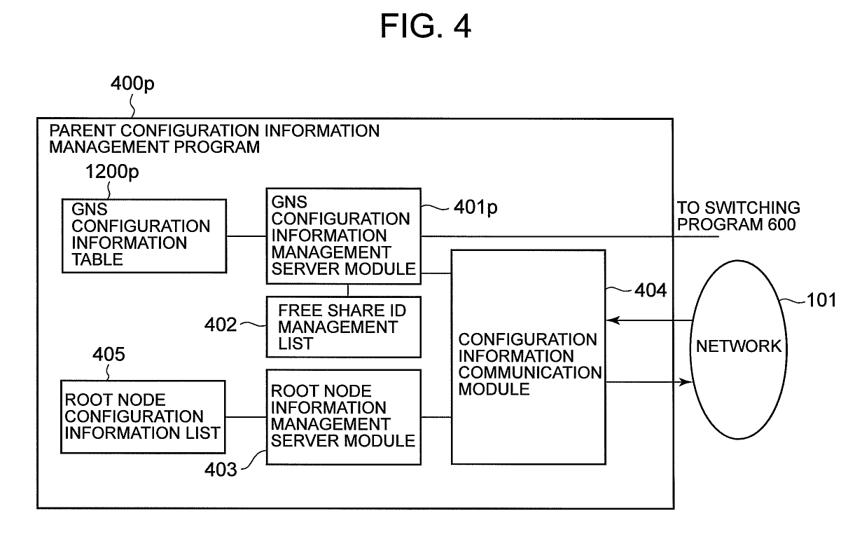

FIG. 4 is a block diagram showing an example of the constitution of a parent configuration information management program 400p.

A parent configuration information management program 400p comprises a GNS configuration information management server module 401p; a root node information management server module 403; and a configuration information communications module 404, and has functions for referencing a free share ID management list 402, a root node configuration information list 405, and a GNS configuration information table 1200p. Lists 402 and 405, and GNS configuration information table 1200p can also be stored in the memory 202.

The GNS configuration information table 1200p is a table for recording GNS configuration definitions, which are provided to a client 100. The details of the GNS configuration information table 1200p will be explained hereinbelow.

The free share ID management list 402 is an electronic list for managing a share ID that can currently be allocated. For example, a share ID that is currently not being used can be registered in the free share ID management list 402, and, by contrast, a share ID that is currently in use can also be recorded in the free share ID management list 402.

The root node configuration information list 405 is an electronic list for registering information (for example, an ID for identifying a root node 200) related to each of one or more root nodes 200.

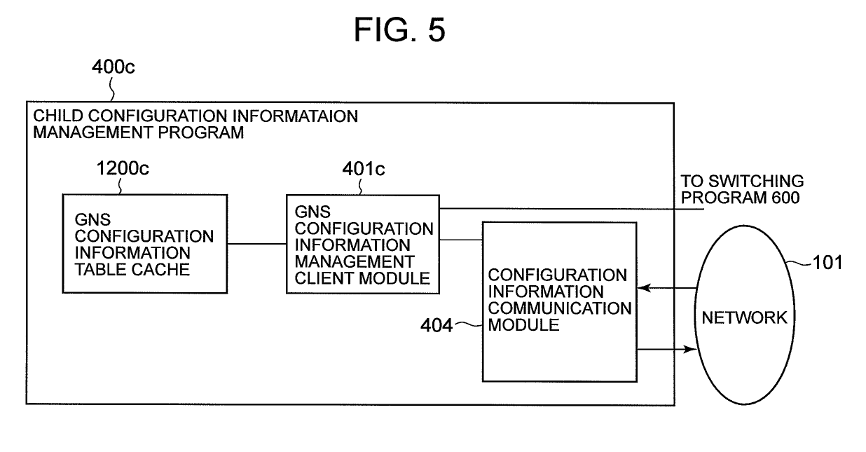

FIG. 5 is a block diagram showing an example of the constitution of a child configuration information management program 400c.

A child configuration information management program 400c comprises a GNS configuration information management client module 401c; and a configuration information communications module 404, and has a function for registering information in a GNS configuration information table cache 1200c.

A GNS configuration information table cache 1200c, for example, is prepared in the memory 202 (or a register of the processor 201). Information of basically the same content as that of the GNS configuration information table 1220p is registered in this cache 1200c. More specifically, the parent configuration information management program 400p notifies the contents of the GNS configuration information table 1200p to a child root node 200c, and the child configuration information management program 400c of the child root node 200c registers these notified contents in the GNS configuration information table cache.

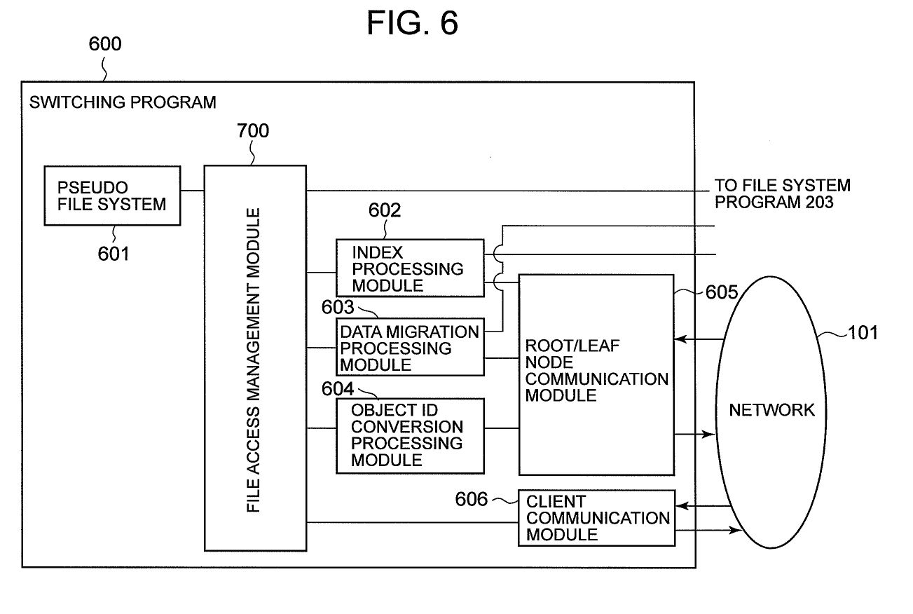

FIG. 6 is a block diagram showing an example of the constitution of the switching program 600.

The switching program 600 comprises a client communications module 606; an root/leaf node communications module 605; a file access management module 700; an object ID conversion processing module 604; a pseudo file system 601; a data migration processing module 603; and an index processing module 602.

The client communications module 606 receives a request (hereinafter, may also be called “request data”) from the client 100, and notifies the received request data to the file access management module 700. Further, the client communications module 606 sends the client 100 a response to the request data from the client 100 (hereinafter, may also be called “response data”) notified from the file access management module 700.

The root/leaf node communications module 605 sends data (request data from the client 100) outputted from the file access management module 700 to either the root node 200 or the leaf node 300. Further, the root/leaf node communications module 605 receives response data from either the root node 200 or the leaf node 300, and notifies the received response data to the file access management module 700.

The file access management module 700 analyzes request data notified from the client communications module 606, and decides the processing method for this request data. Then, based on the decided processing method, the file access management module 700 notifies this request data to the root/leaf node communications module 605. Further, when a request from the client 100 is a request for a file system 207 of its own (own local file system), the file access management module 700 creates response data, and notifies this response data to the client communications module 606. Details of the file access management module 700 will be explained hereinbelow.

The object ID conversion processing module 604 converts an object ID contained in request data received from the client 100 to a format that a leaf node 300 can recognize, and also converts an object ID contained in response data received from the leaf node 300 to a format that the client 100 can recognize. These conversions are executed based on algorithm information, which will be explained hereinbelow.

The pseudo file system 601 is for consolidating either all or a portion of the file system data 207 of the root node 200 or the leaf node 300 to form a single pseudo file system. For example, a root directory and a prescribed directory are configured in the pseudo file system 601, and the pseudo file system 601 is created by mapping a directory managed by either the root node 200 or the leaf node 300 to this prescribed directory.

The data migration processing module 603 processes the migration of data between root nodes 200, between a root node 200 and a leaf node 300, or between leaf nodes 300.

The index processing module 602 conceals from the client 100 the change of object ID that occurs when data is migrated between root nodes 200, between a root node 200 and a leaf node 300, or between leaf nodes 300 (That is, the data migration processing device does not notify the client 100 of the post-data migration object ID.).

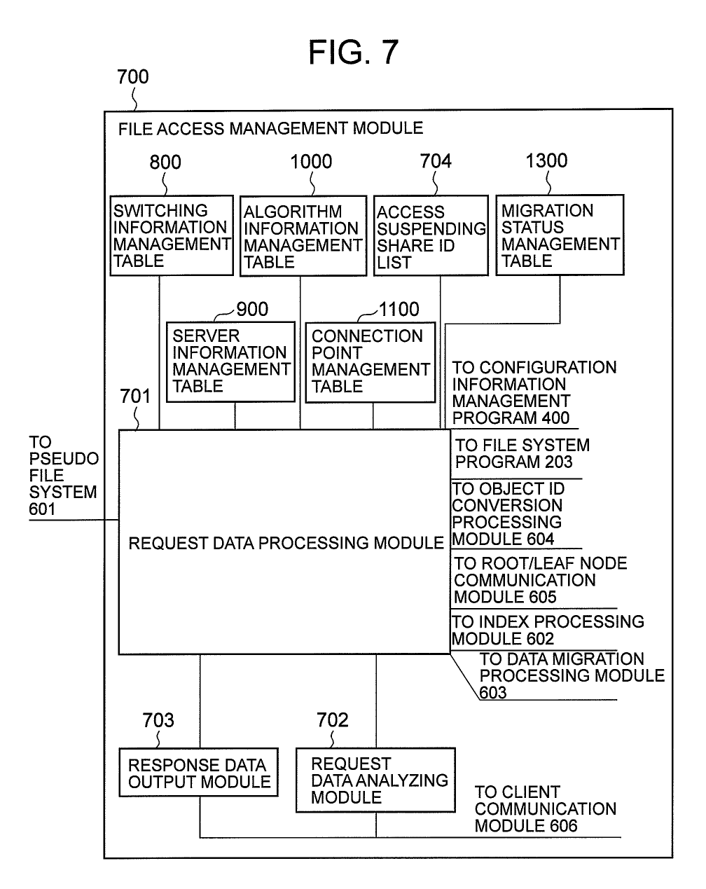

FIG. 7 is a block diagram showing an example of the constitution of the file access management module 700.

The file access management module 700 comprises a request data analyzing module 702; a request data processing module 701; and a response data output module 703, and has functions for referencing a switching information management table 800, a server information management table 900, an algorithm information management table 1000, a connection point management table 1100, a migration status management table 1300, and an access suspending share ID list 704.

The switching information management table 800, server information management table 900, algorithm information management table 1000, migration status management table 1300, and connection point management table 1100 will be explained hereinbelow.

The access suspending share ID list 704 is an electronic list for registering a share ID to which access has been suspended. For example, the share ID of a share unit targeted for migration is registered in the access suspending share ID list 704 either during migration preparation or implementation, and access to the object in this registered share unit is suspended.

The request data analyzing module 702 analyzes request data notified from the client communications module 606. Then, the request data analyzing module 702 acquires the object ID from the notified request data, and acquires the share ID from this object ID.

The request data processing module 701 references arbitrary information from the switching information management table 800, server information management table 900, algorithm information management table 1000, connection point management table 1100, migration status management table 1300, and access suspending share ID list 704, and processes request data based on the share ID acquired by the request data analyzing module 702.

The response data output module 703 converts response data notified from the request data processing module 701 to a format to which the client 100 can respond, and outputs the reformatted response data to the client communications module 606.

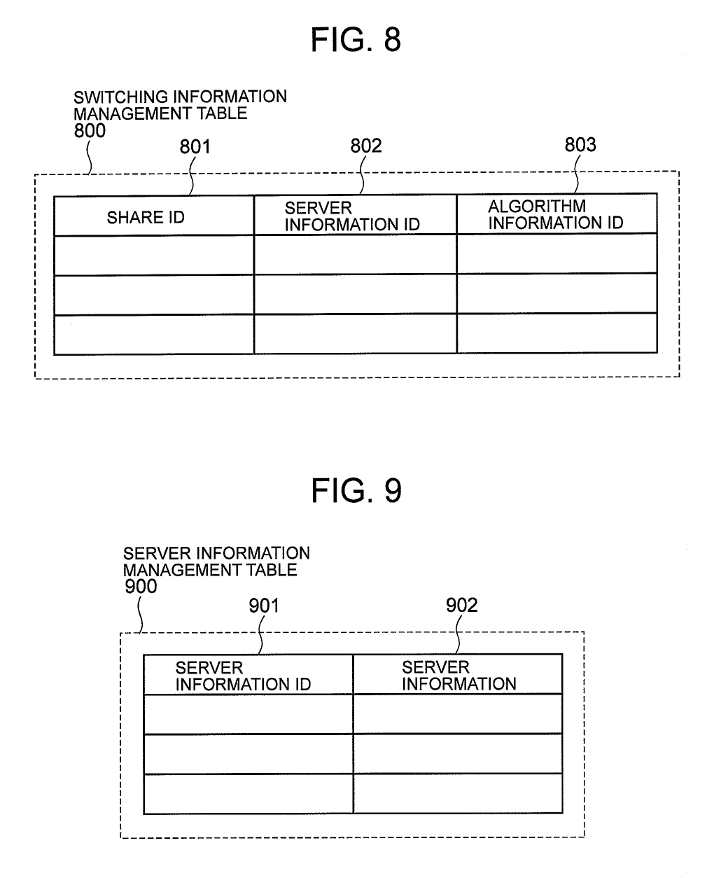

FIG. 8 is a diagram showing an example of the constitution of the switching information management table 800.

The switching information management table 800 is a table, which has entries constituting groups of a share ID 801, a server information ID 802, and an algorithm information ID 803. A share ID 801 is an ID for identifying a share unit. A server information ID 802 is an ID for identifying server information. An algorithm information ID 803 is an ID for identifying algorithm information. The root node 200 can acquire a server information ID 802 and an algorithm information ID 803 corresponding to a share ID 801, which coincides with a share ID acquired from an object ID. In this table 800, a plurality of groups of server information IDs 802 and algorithm information IDs 803 can be registered for a single share ID 801.

FIG. 9 is a diagram showing an example of the constitution of the server information management table 900.

The server information management table 900 is a table, which has entries constituting groups of a server information ID 901 and server information 902. Server information 902, for example, is the IP address or socket structure of the root node 200 or the leaf node 300. The root node 200 can acquire server information 902 corresponding to a server information ID 901 that coincides with an acquired server information ID 702, and from this server information 902, can specify the processing destination of a request from the client 100 (for example, the transfer destination).

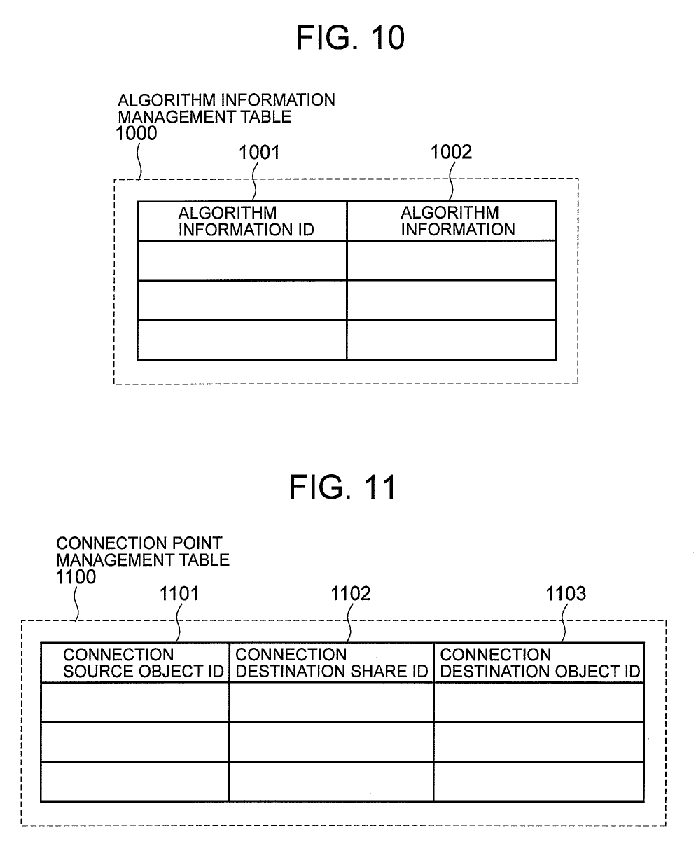

FIG. 10 is a diagram showing an example of the constitution of the algorithm information management table 1000.

The algorithm information management table 1000 is a table, which has entries constituting groups of an algorithm information ID 1001 and algorithm information 1002. Algorithm information 1002 is information showing an object ID conversion mode. The root node 200 can acquire algorithm information 1002 corresponding to an algorithm information ID 1001 that coincides with an acquired algorithm information ID 1001, and from this algorithm information 1002, can specify how an object ID is to be converted.

Furthermore, in this embodiment, the switching information management table 800, server information management table 900, and algorithm information management table 1000 are constituted as separate tables, but these can be constituted as a single table by including server information 902 and algorithm information 1002 in a switching information management table 800.

FIG. 11 is a diagram showing an example of the constitution of the connection point management table 1100.

The connection point management table 1100 is a table, which has entries constituting groups of a connection source object ID 1101, a connection destination share ID 1102, and a connection destination object ID 1103. By referencing this table, the root node 200 can just access a single share unit for the client 100 even when the access extends from a certain share unit to another share unit. Furthermore, the connection source object ID 1101 and connection destination object ID 1103 here are identifiers (for example, file handles or the like) for identifying an object, and can be exchanged with the client 100 by the root node 200, or can be such that an object is capable of being identified even without these object IDs 1101 and 1103 being exchanged between the two.

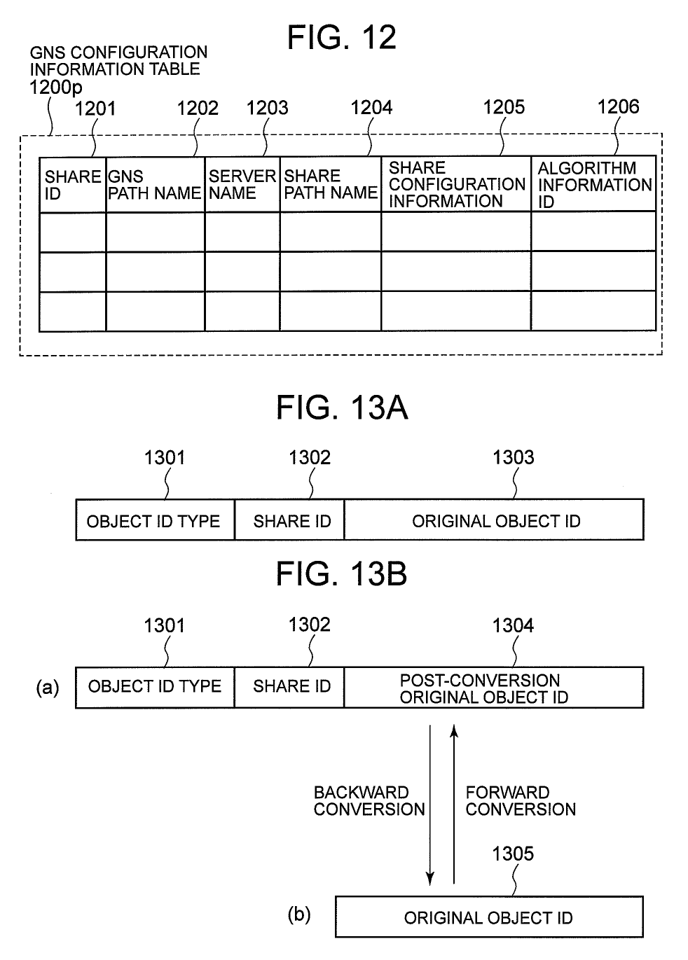

FIG. 12 is a diagram showing an example of the constitution of the GNS configuration information table 1200.

The GNS configuration information table 1200 is a table, which has entries constituting groups of a share ID 1201, a GNS path name 1202, a server name 1203, a share path name 1204, share configuration information 1205, and an algorithm information ID 1206. This table 1200, too, can have a plurality of entries comprising the same share ID 1201, the same as in the case of the switching information management table 800. The share ID 1201 is an ID for identifying a share unit. A GNS path name 1202 is a path for consolidating share units corresponding to the share ID 1201 in the GNS. The server name 1203 is a server name, which possesses a share unit corresponding to the share ID 1201. The share path name 1204 is a path name on the server of the share unit corresponding to the share ID 1201. Share configuration information 1205 is information related to a share unit corresponding to the share ID 1201 (for example, information set in the top directory (root directory) of a share unit, more specifically, for example, information for showing read only, or information related to limiting the hosts capable of access). An algorithm information ID 1206 is an identifier of algorithm information, which denotes how to carry out the conversion of an object ID of a share unit corresponding to the share ID 1201.

FIG. 13A is a diagram showing an example of an object ID exchanged in the case of an extended format OK. FIG. 13B is a diagram showing an object ID exchanged in the case of an extended format NG.

An extended format OK case is a case in which a leaf node 300 can interpret the object ID of share ID type format format, an extended format NG case is a case in which a leaf node 300 cannot interpret the object ID of share ID type format format, and in each case the object ID exchanged between devices is different.

Share ID type format format is format for an object ID, which extends an original object ID, and is prepared using three fields. An object ID type 1301, which is information showing the object ID type, is written in the first field. A share ID 1302 for identifying a share unit is written in the second field. In an extended format OK case, an original object ID 1303 is written in the third field as shown in FIG. 13A, and in an extended format NG case, a post-conversion original object ID 1304 is written in the third field as shown in FIG. 13B (a).

The root node 200 and some leaf nodes 300 can create an object ID having share ID type format format. In an extended format OK case, share ID type format format is used in exchanges between the client 100 and the root node 200, the root node 200 and a root node 200, and between the root node 200 and the leaf node 300, and the format of the object ID being exchanged does not change.

As described hereinabove, in an extended format OK case, the original object ID 1303 is written in the third field, and this original object ID 1303 is an identifier (for example, a file ID) for either the root node 200 or the leaf node 300, which possesses the object, to identify this object in this root node 200 or leaf node 300.

Conversely, in an extended format NG case, an object ID having share ID type format as shown in FIG. 13B (a) is exchanged between the client 100 and the root node 200, and between the root node 200 and a root node 200, and a post-conversion original object ID 1304 is written in the third field as described above. Then, an exchange is carried out between the root node 200 and the leaf node 300 using an original object ID 1305 capable of being interpreted by the leaf node 300 as shown in FIG. 13B (b). That is, in an extended format NG case, upon receiving an original object ID 1305 from the leaf node 300, the root node 200 carries out a forward conversion, which converts this original object ID 1305 to information (a post-conversion object ID 1304) for recording in the third field of the share ID type format. Further, upon receiving an object ID having share ID type format, a root node 200 carries out backward conversion, which converts the information written in the third field to the original object ID 1305. Both forward conversion and backward conversion are carried out based on the above-mentioned algorithm information 1002.

More specifically, for example, the post-conversion original object ID 1304 is either the original object ID 1305 itself, or is the result of conversion processing being executed on the basis of algorithm information 1002 for either all or a portion of the original object ID 1305. For example, if the object ID is a variable length, and a length, which adds the length of the first and second fields to the length of the original object ID 1305, is not more than the maximum length of the object ID, the original object ID 1305 can be written into the third field as the post-conversion original object ID 1304. Conversely, for example, when the data length of the object ID is a fixed length, and this fixed length is exceeded by adding the object ID type 1301 and the share ID 1302, conversion processing is executed for either all or a portion of the original object ID 1305 based on the algorithm information 1002. In this case, for example, the post-conversion original object ID 1304 is converted so as to become shorter that the data length of the original object ID 1305 by deleting unnecessary data.

Next, the operation of the root node 200 will be explained. As described hereinabove, the root node 200 consolidates a plurality of share units to form a single pseudo file system, that is, the root node 200 provides the GNS to the client 100.

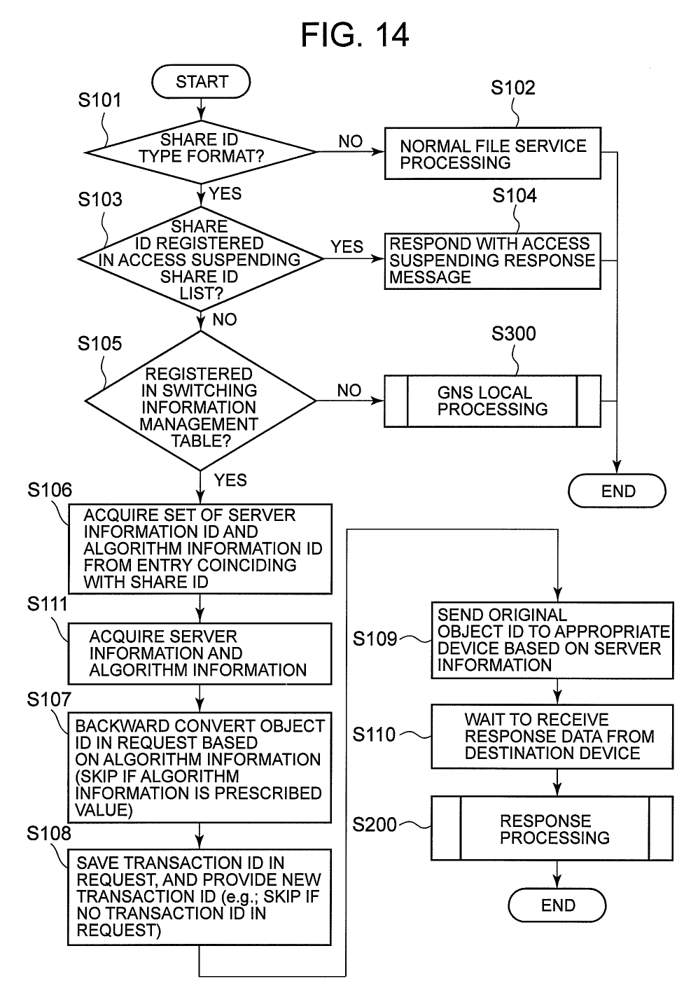

FIG. 14 is a flowchart of processing in which the root node 200 provides the GNS.

First, the client communications module 606 receives from the client 100 request data comprising an access request for an object. The request data comprises an object ID for identifying the access-targeted object. The client communications module 606 notifies the received request data to the file access management module 700. The object access request, for example, is carried out using a remote procedure call (RPC) of the NFS protocol. The file access management module 700, which receives the request data notification, extracts the object ID from the request data. Then, the file access management module 700 references the object ID type 1301 of the object ID, and determines whether or not the format of this object ID is share ID type format (S101).

When the object ID type is not share ID type format (S101: NO), conventional file service processing is executed (S102), and thereafter, processing is ended.

When the object ID type is share ID type format (S101: YES), the file access management module 700 acquires the share ID 1302 contained in the extracted object ID. Then, the file access management module 700 determines whether or not there is a share ID that coincides with the acquired share ID 1302 among the share IDs registered in the access suspending share ID list 704 (S103).

When the acquired share ID 1302 coincides with a share ID registered in the access suspending share ID list 704 (S103: YES), the file access management module 700 sends to the client 100 via the client communications module 606 response data to the extent that access to the object corresponding to the object ID contained in the request data is suspended (S104), and thereafter, processing ends.

When the acquired share ID 1302 does not coincide with a share ID registered in the access suspending share ID list 704 (S103: NO), the file access management module 700 determines whether or not there is an entry comprising a share ID 801 that coincides with the acquired share ID 1302 in the switching information management table 800 (S105). As explained hereinabove, there could be a plurality of share ID 801 entries here that coincide with the acquired share ID 1302.

When there is no matching entry (S105: NO), a determination is made that this root node 200 should process the received request data, the file system program 203 is executed, and GNS local processing is executed (S300). GNS local processing will be explained in detail hereinbelow.

When there is a matching entry (S105: YES), a determination is made that a device other than this root node 200 should process the received request data, and a group of one set of a server information ID 802 and algorithm information ID 803 is acquired from the coinciding share ID 801 entry (S106). When there is a plurality of coinciding entries, for example, one entry is selected either in round-robin fashion, or on the basis of a previously calculated response time, and a server information ID 802 and algorithm information ID 803 are acquired from this selected entry.

Next, the file access management module 700 references the server information management table 900, and acquires server information 902 corresponding to a server information ID 901 that coincides with the acquired server information ID 802. Similarly, the file access management module 700 references the algorithm information management table 1000, and acquires algorithm information 1002 corresponding to an algorithm information ID 1001 that coincides with the acquired algorithm information ID 803 (S111).

Thereafter, if the algorithm information 1002 is not a prescribed value (for example, a value of 0), the file access management module 700 indicates that the object ID conversion processing module 604 carry out a backward conversion based on the acquired algorithm information 1002 (S107), and conversely, if the algorithm information 1002 is a prescribed value, the file access management module 700 skips this S107. In this embodiment, the fact that the algorithm information 1002 is a prescribed value signifies that request data is transferred to another root node 200. That is, in the transfer between root nodes 200, the request data is simply transferred without having any conversion processing executed. That is, the algorithm information 1002 is information signifying an algorithm that does not make any conversion at all (that is, the above prescribed value), or information showing an algorithm that only adds or deletes an object ID type 1301 and share ID 1302, or information showing an algorithm, which either adds or deletes an object ID type 1301 and share ID 1302, and, furthermore, which restores the original object ID 1303 from the post-conversion original object ID 1304.

Next, when the protocol is for executing transaction processing at the file access request level, and the request data comprises a transaction ID, the file access management module 700 saves this transaction ID, and provides the transaction ID to either the root node 200 or the leaf node 300, which is the request data transfer destination device (S108). Either transfer destination node 200 or 300 can reference the server information management table 900, and can identify server information from the server information 902 corresponding to the server information ID 901 of the acquired group. Furthermore, if the above condition is not met (for example, when a transaction ID is not contained in the request data), the file access management module 700 can skip this S108.

Next, the file access management module 700 sends via the root/leaf node communications module 605 to either node 200 or 300, which was specified based on the server information 902 acquired in S111, the received request data itself, or request data comprising the original object ID 1305 (S109). Thereafter, the root/leaf node communications module 605 waits to receive response data from the destination device (S110).

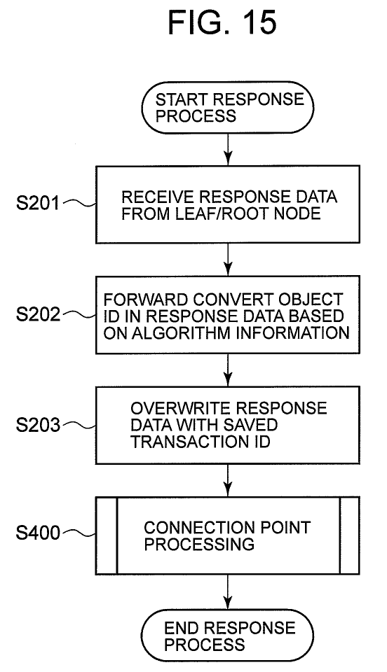

Upon receiving the response data, the root/leaf node communications module 605 executes response processing (S200). Response processing will be explained in detail using FIG. 15.

FIG. 15 is a flowchart of processing (response processing) when the root node 200 receives response data.

The root/leaf node communications module 605 receives response data from either the leaf node 300 or from another root node 200 (S201). The root/leaf node communications module 605 notifies the received response data to the file access management module 700.

When there is an object ID in the response data, the file access management module 700 indicates that the object ID conversion processing module 604 convert the object ID contained in the response data. The object ID conversion processing module 604, which receives the indication, carries out forward conversion on the object ID based on the algorithm information 1002 referenced in S107 (S202). If this algorithm information 1002 is a prescribed value, this S202 is skipped.

When the protocol is for carrying out transaction management at the file access request level, and the response data comprises a transaction ID, the file access management module 700 overwrites the response message with the transaction ID saved in S108 (S203). Furthermore, when the above condition is not met (for example, when a transaction ID is not contained in the response data), this S203 can be skipped.

Thereafter, the file access management module 700 executes connection point processing, which is processing for an access that extends across share units (S400). Connection point processing will be explained in detail below.

Thereafter, the file access management module 700 sends the response data to the client 100 via the client communications module 606, and ends response processing.

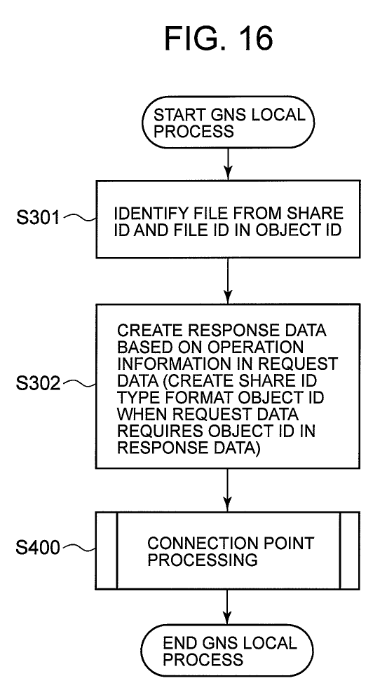

FIG. 16 is a flowchart of GNS local processing executed by the root node 200.

First, an access-targeted object is identified from the share ID 1302 and original object ID 1303 in an object ID extracted from request data (S301).

Next, response data is created based on information, which is contained in the request data, and which denotes an operation for an object (for example, a file write or read) (S302). When it is necessary to include the object ID in the response data, the same format as the received format is utilized in the format of this object ID.

Thereafter, connection point processing is executed by the file access management module 700 of the switching program 600 (S400).

Thereafter, the response data is sent to the client 100.

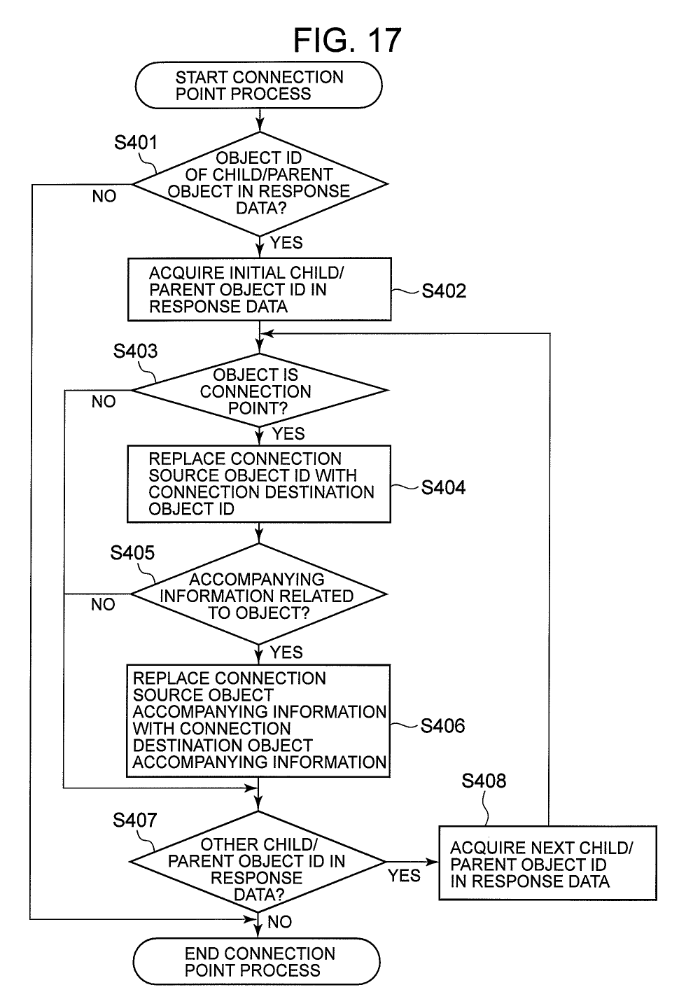

FIG. 17 is a flowchart of connection point processing executed by the root node 200.

First, the file access management module 700 checks the access-targeted object specified by the object access request (request data), and ascertains whether or not the response data comprises one or more object IDs of either a child object (a lower-level object of the access-targeted object in the directory tree) or a parent object (a higher-level object of the access-targeted object in the directory tree) of this object (S401). Response data, which comprises an object ID of a child object or parent object like this, for example, corresponds to response data of a LOOKUP procedure, READDIR procedure, or READDIRPLUS procedure under the NFS protocol. When the response data does not comprise an object ID of either a child object or a parent object (S401: NO), processing is ended.

When the response data comprises one or more object IDs of either a child object or a parent object (S401: YES), the file access management module 700 selects the object ID of either one child object or one parent object in the response data (S402).

Then, the file access management module 700 references the connection point management table 1100, and determines if the object of the selected object ID is a connection point (S403). More specifically, the file access management module 700 determines whether or not the connection source object ID 1101 of this entry, of the entries registered in the connection point management table 1100, coincides with the selected object ID.

If there is no coinciding entry (S403: NO), the file access management module 700 ascertains whether or not the response data comprises an object ID of another child object or parent object, which has yet to be selected (S407). If the response data does not comprise the object ID of any other child object or parent object (S407: NO), connection point processing is ended. If the response data does comprise the object ID of either another child object or parent object (S407: YES), the object ID of one as-yet-unselected either child object or parent object is selected (S408). Then, processing is executed once again from S403.

If there is a coinciding entry (S403: YES), the object ID in this response data is substituted for the connection destination object ID 1103 corresponding to the connection source object ID 1101 that coincides therewith (S404).

Next, the file access management module 700 determines whether or not there is accompanying information related to the object of the selected object ID (S405). Accompanying information, for example, is information showing an attribute related to this object. When there is no accompanying information (S405: NO), processing moves to S407. When there is accompanying information (S405: YES), the accompanying information of the connection source object is replaced with the accompanying information of the connection destination object (S406), and processing moves to S407.

The modules related to data migration in this embodiment will be explained in particular detail hereinbelow.

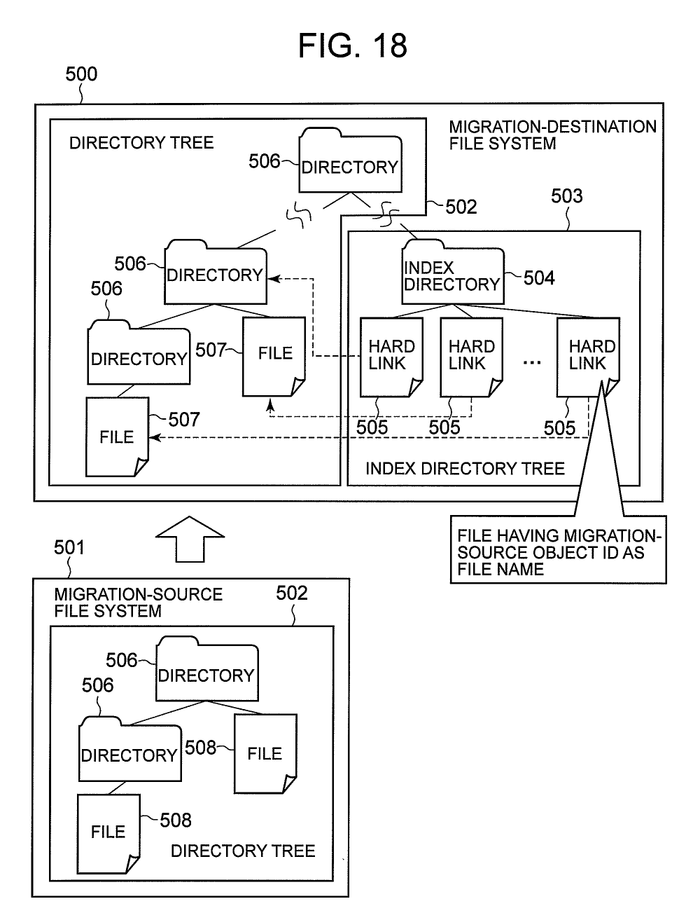

FIG. 18 is a diagram showing examples of the constitutions of a migration-source file system 501 and a migration-destination file system 500.

The migration-source file system 501 is either file system 207 or 307 managed by a device of the data migration source (either a root node 200 or a leaf node 300, and hereinafter may be called “either migration-source node 200 or 300”). Conversely, the migration-destination file system 502 is either file system 207 or 307 managed by a device of the data migration destination (either a root node 200 or a leaf node 300, and hereinafter may be called “either migration-destination node 200 or 300”).

In the migration-source file system 501 and migration-destination file system 500, directories 506 and files 507/508 are managed hierarchically by a directory tree 502. Further, an index directory tree 503 is constructed in the migration-destination file system 500.

A file under the index directory 504 is a hard link 505 to a migration-destination file 507, which makes the object ID of the migration-source file 508 (migration-source object ID) the file name. The hard link is a link to the entity of a directory or file in the file system, and, for example, in the case of a UNIX (registered trademark) file system, means that the i-node, which is an unique ID of a directory or file, is the same. Furthermore, this hard link 505 can also be a symbolic link or other such link, as long as it is a file that points to a migration-destination file 507. That is, the index directory tree 503 is a tree denoting the corresponding relationship between the pre-migration object ID in either migration-source node 200 or 300 (migration-source object ID) and the post-migration object ID in either migration-destination node 200 or 300 (migration-destination object ID). The index processing module 602 can specify a migration-destination object ID corresponding to a migration-source object ID from the index directory tree 503. The corresponding relationship between the migration-source object ID and the migration-destination object ID does not necessarily have to be managed by the directory tree, and, for example, can be managed by a table. However, since the directory tree is management information, which can be created by either file system program 203 or 303, directory tree management can eliminate the need to provide a new table creation function in either migration-destination node 200 or 300.

More specifically, when migrating data between root nodes 200, between a root node 200 and a leaf node 300, or between leaf nodes 300, the data migration processing module 603 issues an index directory tree 503 create indication to either migration-destination node 200 or 300, and the index directory tree 503 is created in accordance with this create indication by either file system program 203 or 303 of either migration-destination node 200 or 300. This create indication comprises information (hereinafter, index directory definition information) showing the structure of the directory tree to be created, and the object names to be arranged in the respective tree nodes (directory points). More specifically, the index directory definition information designates where in the migration-destination file system 500 to position the index directory 504, and what hard links 505 (hard links 505 having which migration-source object IDs as file names) to create under this index directory 504. Either file system program 203 or 303 of either migration-destination node 200 or 300 creates an index directory tree 503 like the example shown in FIG. 5 in accordance with this index directory definition information. The index directory tree 503 is a normal directory tree, and therefore, as explained hereinabove, can be created by either file system program 203 or 303 of either migration-destination node 200 or 300.

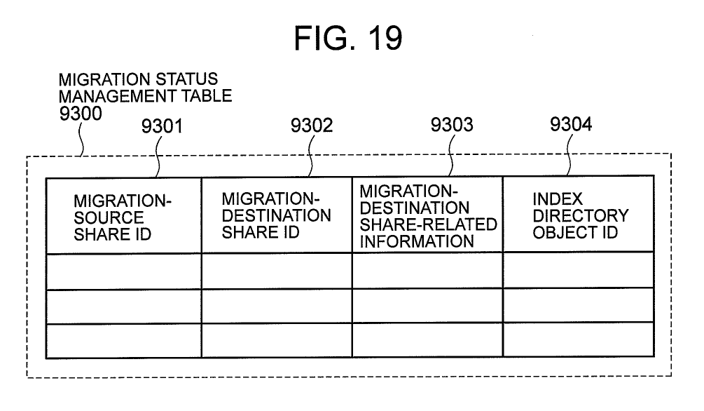

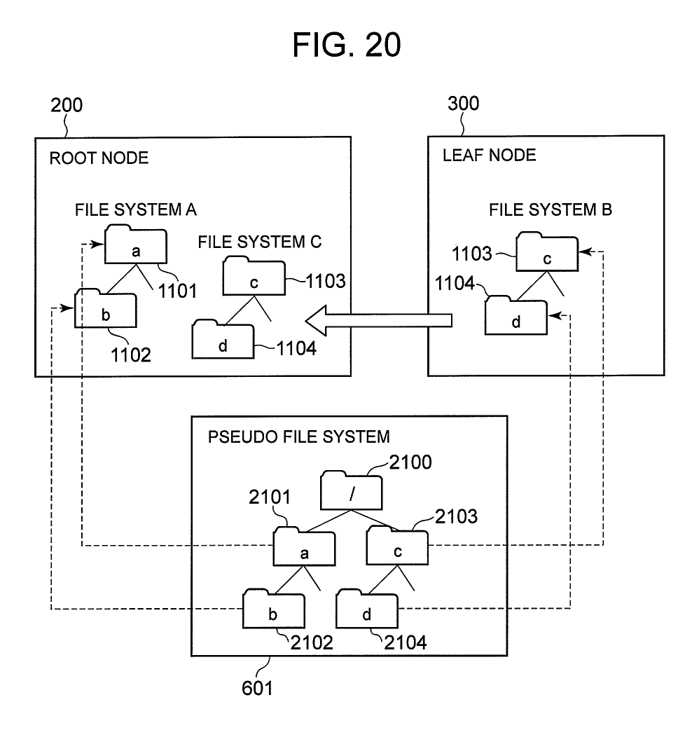

FIG. 19 is a diagram showing an example of the constitution of a migration status management table 9300 in the first embodiment.

The migration status management table 9300 is a table having an entry constituted by a group comprising a migration-source share ID 9301, a migration-destination share ID 9302, migration-destination share-related information 9303, and an index directory object ID 9304. The migration-source share ID 9301 is an ID for identifying a share unit of a migration source. The migration-destination share ID 9302 is an ID for identifying a share unit of a migration destination. Migration-destination share-related information 9303 is information related to a share unit of a data migration destination, and, for example, is information comprising information, which denotes whether or not a share unit of a data migration destination is a local file system, and information, which denotes whether or not there is a function in either migration-destination node 200 or 300 for tracking the index directory. The index directory object ID 9304 is an ID (can be a path name, for example) for identifying the index directory 504.

Operations related to the data migration processing of a root node 200 will be explained hereinbelow.

A root node 200 can alleviate insufficient capacity in the storage units 206 of a root node 200 and a leaf node 300, and can reduce the load of file access processing on the root node 200 and the leaf node 300 while concealing the migration of data from the client 100 by maintaining the structure (GNS structure) of the directory tree in the pseudo file system 401 as-is, and, after migrating a file in the share unit constituting this directory tree (a tree structure based on the exported directory of the leaf node 300) to either another root node 200 or leaf node 300, changing the mapping of this share unit.

For example, in the pseudo file system 401 in FIG. 20, it is supposed that the file access processing load on file system A of the root node 200 is low and the file access processing load on file system B of the leaf node 300 is high, thus making it desirable to copy file system B of the leaf node 300 to the root node 200. Under these circumstances, the root node 200 of this embodiment, as shown in FIG. 20, can lower the load on the leaf node while concealing the migration of data from the client 100 by copying the directory tree of file system B to file system C, and only changing the mapping information without changing the directory structure of the pseudo file system 401.

The procedures of data migration processing will be explained in detail.

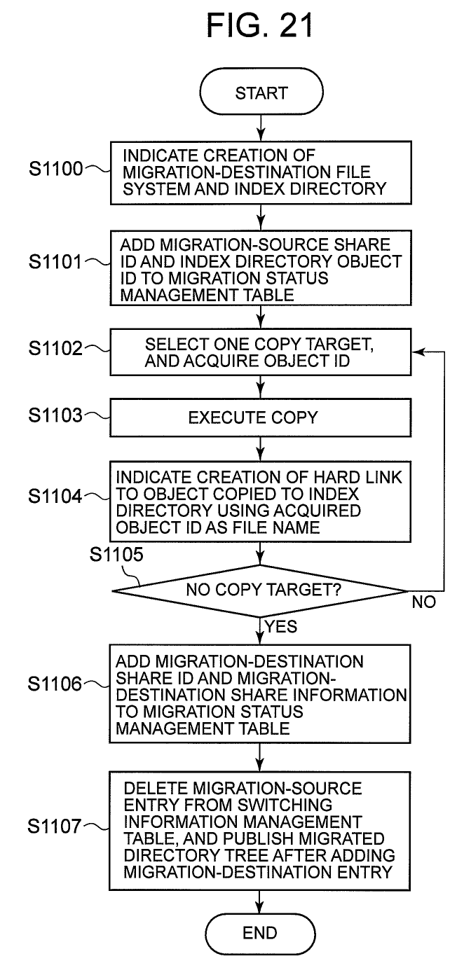

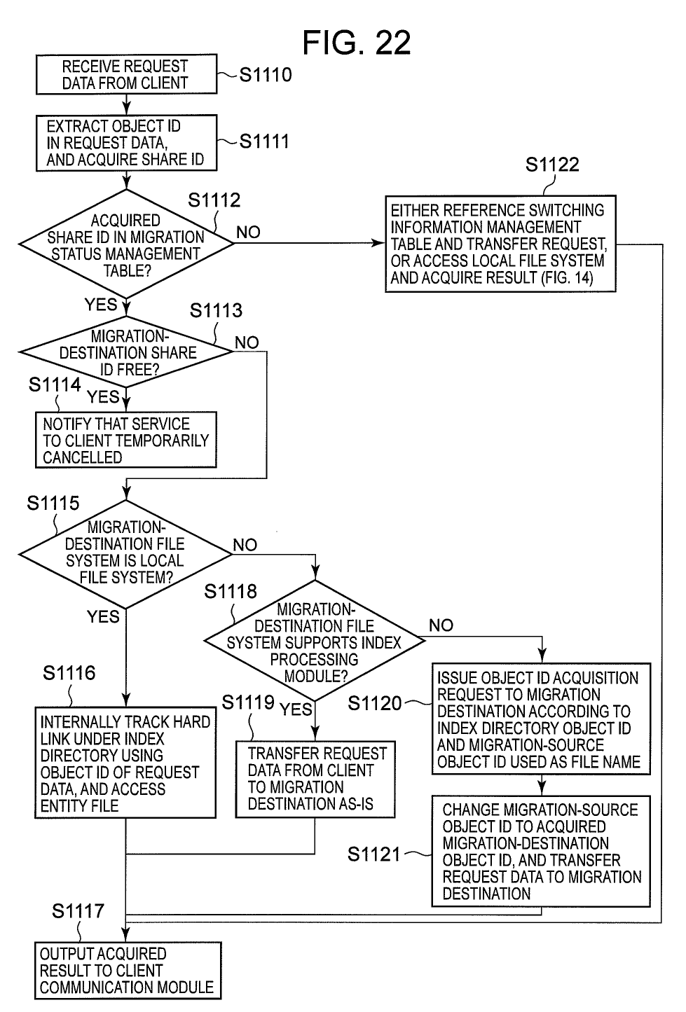

FIG. 21 is a flowchart of data migration processing in the first embodiment.

This data migration processing, for example, is started in response to the root node 200 receiving a prescribed indication from a setting device (for example, a management computer). In this prescribed indication, for example, there is specified a share ID for identifying the migration target share unit, and information for specifying either migration-destination node 200 or 300 (hereinafter, the migration-destination server name). Hereinafter, it is supposed that this share unit is an entire file system.

In S1100, the data migration processing module 603 in this root node 200 creates in either migration-destination node 200 or 300 a migration-destination file system 500 which has enough size to store storing a migration target directory tree in the migration-source file system 501 of either migration-source node 200 or 300. Further, the data migration processing module 603 sends to either migration-destination node 200 or 300 a create indication for creating an index directory 504 in a specified location of the migration-destination file system 500 (for example, directly under the root directory). Either file system program 203 or 303 of either migration-destination node 200 or 300 responds to this create indication, and creates an index directory 504 in the specified location of the migration-destination file system 500.

In S1101, the data migration processing module 603 registers the migration-source share ID 9301 (for example, the share ID, which is specified by the above-mentioned prescribed indication), and the object ID 1304 of the index directory 504 created in S1100 in the migration status management table 9300 of the file access manager 700. This object ID 9304, for example, is an object ID, which is stipulated by the data migration processing module 603 using a prescribed rule. Further, this object ID, for example, is an object ID of share ID type format formatting. From the point of this S1101, the file access manager 700 transitions to a state in which a request from the client 100 is temporarily not accepted for a share unit identified from at least the migration-source share ID 9301 (for example, by registering this migration-source share ID 9301 in the access suspending share ID list 704).

In S1102, the data migration processing module 603 selects either copy target directory 506 or file 507 from the migration-source file system 501, and acquires the migration-source object ID of the selected either directory 506 or file 507.

In S1103, the data migration processing module 603 copies either directory 506 or file 507, which was selected in S1102, to the migration-destination file system 500 from the migration-source file system 501.

In S1104, the data migration processing module 603 indicates to either migration-destination node 200 or 300, which is managing the migration-destination file system 500, to create a hard link 505, which is a link file related to the copy-destination directory 506 and/or file 507, in the index directory 504 created in Step S1100. More specifically, for example, the data migration processing module 603 indicates to either migration-destination node 200 or 300 a link file create indication (for example, an indication, which specifies a migration-source object ID as a hard link 505 file name, and the location of the hard link 505) for positioning under (for example, directly beneath) the index directory 504 created in S1100 a hard link 505, which has the migration-source object ID acquired in S1102 as the file name. Either file system program 203 or 303 of either migration-destination node 200 or 300 creates a hard link 505 having the migration-source object ID as the file name under the index directory 504 in accordance with this indication.

The data migration processing module 603 repeats steps S1102, S1103 and S1104 while tracking the directory tree in the migration-source file system 501 until the copy target is gone (S1105). When the copy target is gone, processing moves to S1106.

In S1106, the data migration processing module 603 adds the migration-destination share ID 9302 and the migration-destination share-related information 9303 to the entry comprising the relevant migration-source share ID 9301 of the migration status management table 9300. This migration-destination share ID 9302, for example, is a value, which is decided by a prescribed rule (for example, by using the free share ID management list 402). Further, the migration-destination share-related information 9303 is information comprising information, which denotes whether or not the migration-destination file system 500 is the own local file system for the root node 200 having this data migration processing module 603, and information, which denotes whether or not there is a function for tracking the index directory in either migration-destination node 200 or 300. This migration-destination share-related information 9303, for example, can be specified by an administrator, or can be specified from server information and the like denoting either migration-destination node 200 or 300.

In S1107, the data migration processing module 603 deletes from the switching information management table 800 an entry comprising share ID 801, which coincides with the migration-source share ID 9301. Further, after adding an entry, which is made up from a group comprising a share ID 801 that coincides with the migration-destination share ID 9302, a server information ID 702 corresponding to server information denoting either migration-destination node 200 or 300, and an algorithm information ID 703 for identifying algorithm information suited to this server information, the data migration processing module 603 publishes a directory tree in the migration-destination file system 500. At this time, the file access manager 700 resumes receiving requests from the client 100 (for example, deletes the share ID coinciding with the migration-source share ID 9301 from the access suspending share ID list 704). Furthermore, as for the value of the algorithm information ID 703, when the device, which has the migration-destination file system 500 as the own local file system, is a root node 200, for example, the algorithm information ID 703 corresponds to algorithm information of a prescribed value.

Next, the processing procedures when request data is received from the client 100 subsequent to a data migration process will be explained in detail.

FIG. 22 is a flowchart of processing executed by the root node 200, which receives request data from the client 100 in the first embodiment.

In S1110, the client communication module 606 receives request data from the client 100, and outputs same to the file access manager 700.

In S1111, the file access manager 700 extracts the object ID in the request data, and acquires the share ID from this object ID.

In S1112, the file access manager 700 determines whether or not the migration status management table 9300 has an entry (hereinafter referred to as a relevant entry), which comprises a migration-source share ID 9301 coinciding with the share ID acquired in S1111. If this entry is determined to exist, processing moves to S1113, and if this entry is determined not to exist, processing moves to S1122.

In S1113, the file access manager 700 determines whether or not the migration-destination share ID 9302 of the relevant entry is free. If it is determined to be free, processing moves to S1114, and if it is determined not to be free, processing moves to S1115.

Moving to S1114 signifies that data migration processing has not ended. Thus, in S1114, the file access manager 700 creates response data comprising an error showing that service is temporarily suspended, and outputs this response data to the client communication module 606. When the file sharing protocol is NFS, for example, the error showing that service is temporarily suspended is the JUKEBOX error.

In S1115, the file access manager 700 references the migration-destination share-related information 9303 in the relevant entry, and determines whether or not the migration-destination file system 500 is the own local file system. If it is determined to be the own local file system, processing moves to S1116, and if it is determined not to be the own local file system, processing moves to S1118.

In S1116, the index processing module 602 identifies the index directory 504 from the index directory object ID 9304 in the relevant entry. Then, the index processing module 602 internally tracks the hard link 505, which has the object ID extracted from the request data in S1111 as its file name, and executes the file access processing requested by the client 100 (that is, executes processing in accordance with the request data). Internally tracking the hard link 505, for example, refers to accessing the desired directory 506 and file 507 without going through the file sharing protocol, by using i-node information obtained by the hard link 505 when the file system 207 is a UNIX system.

In S1117, the file access manager 700 outputs the acquired result to the client communication module 606. The acquired result, for example, is response data showing the success or failure of an access, and when the migration destination is remote, is the response data of the transferred request data.

In S1118, the file access manager 700 determines whether or not the migration-destination file system 500 corresponds to the index processing module 602, that is, whether or not either migration-destination node 200 or 300 have a function for tracking the index directory. This determination is made by referencing the migration-destination share-related information 9303 in the relevant entry of the migration status management table 9300. When there is a function for tracking the index directory in either migration-destination node 200 or 300, processing moves to S1119, and when there is not, processing moves to S1120.

In S1119, the file access manager 700 specifies from the switching information management table 800 an entry, which comprises a share ID 801 coinciding with the migration-destination share ID 9302 in the relevant entry. The file access manager 700 specifies server information 902 corresponding to the server information ID 901 that coincides with the server information ID 802 in the specified entry, and specifies either migration-destination node 200 or 300 from this server information 902. The file access manager 700 transfers request data to either migration-destination node 200 or 300 via the root/leaf node communication module 605.

In S1120, the index processing module 602 references the switching information management table 800 and the migration status management table 9300 via the file access manager 700. The index processing module 602 acquires both a switching information management table 800 entry comprising a share ID 801 coinciding with the migration-destination share ID 9302, and the index directory object ID 9304 in the above-mentioned relevant entry. Next, the index processing module 602, using the index directory object ID 9304 and the object ID extracted in S1111, issues a request to either migration-destination node 200 or 300, which corresponds to the entry acquired from the switching information management table 800, to acquire the object ID of the hard link 505, which is in the index directory 504, and which has the object ID extracted in S1111 as its file name. A request to acquire an object ID, for example, is a LOOKUP request in the case of NFS. In an NFS LOOKUP request, issuing the request using the object ID of the directory and the object name makes it possible to acquire the object ID of an object in this directory.

In S1121, the file access manager 700 changes the object ID in request data from the client 100 to a post-data migration processing object ID, and transfers this request data (for example, a file access request) to the above-mentioned either migration-destination node 200 or 300. A post-data migration processing object ID is the result obtained by the request of S1120.

In S1122, the file access manager 700 acquires from the switching information management table 800 an entry corresponding to the share ID in the object ID in request data, and either transfers same to the appropriate either migration-destination node 200 or 300 via the root/leaf node communication module 605, or accesses the own local file system. In this S1122, for example, the processing explained by referring to FIG. 14 is executed.

The preceding is an explanation of the first embodiment.

In this first embodiment, when the root node 200, which receives request data, and either migration-destination node 200 or 300, which has the access-destination object specified in the request data (the object identified from the specified object ID), are different, a request transfer process for transferring the request data is carried out by this root node 200, but an object search process for searching for the access-destination object is carried out by either migration-destination node 200 or 300. Thus, the load on the root node 200, which receives the request data, can be decreased. Then, in the first embodiment, there is no need to synchronize the corresponding relationship of object IDs between root nodes 200. The realization of high scalability can be expected based on these effects.

### Second Embodiment

Next, a second embodiment of the present invention will be explained. Hereinafter, the explanation will focus mainly on the points of difference with the first embodiment, and explanations of the points in common with the first embodiment will be omitted or simplified (This also holds true for the third embodiment, which will be explained hereinbelow.).

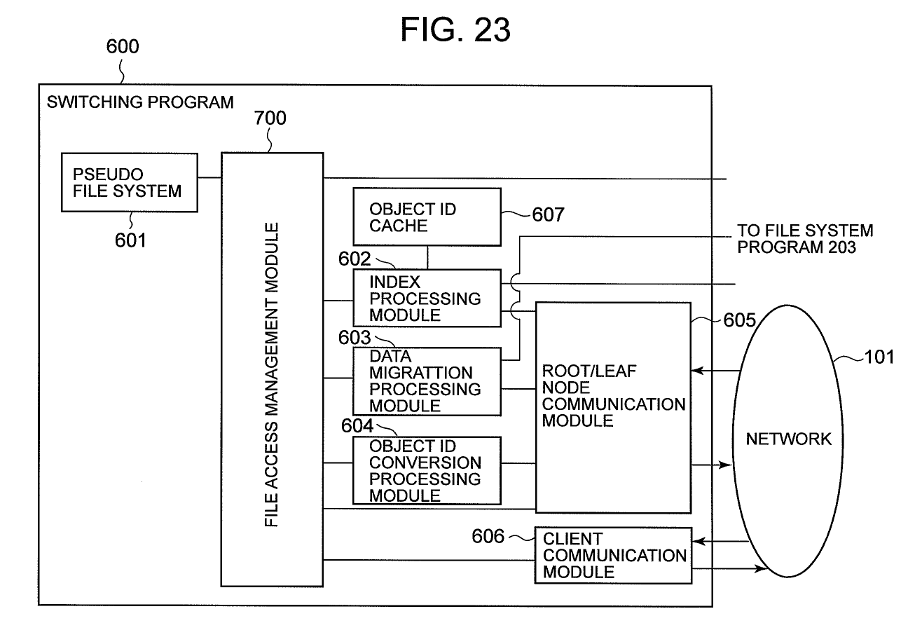

In a root node 200 of the second embodiment, the switching program 600 further comprises an object ID cache 607 as shown in FIG. 23.

A root node 200 of this embodiment has a function for temporarily holding an acquired object ID in the object ID cache 607 when either migration-destination node 200 or 300 do not possess an index processing module 602, and do not correspond to the index directory 504. Accordingly, an object ID acquisition request can be efficiently issued to either migration-destination node 200 or 300.

The processing procedures when the root node 200 receives request data from the client 100 will be explained in detail hereinbelow.

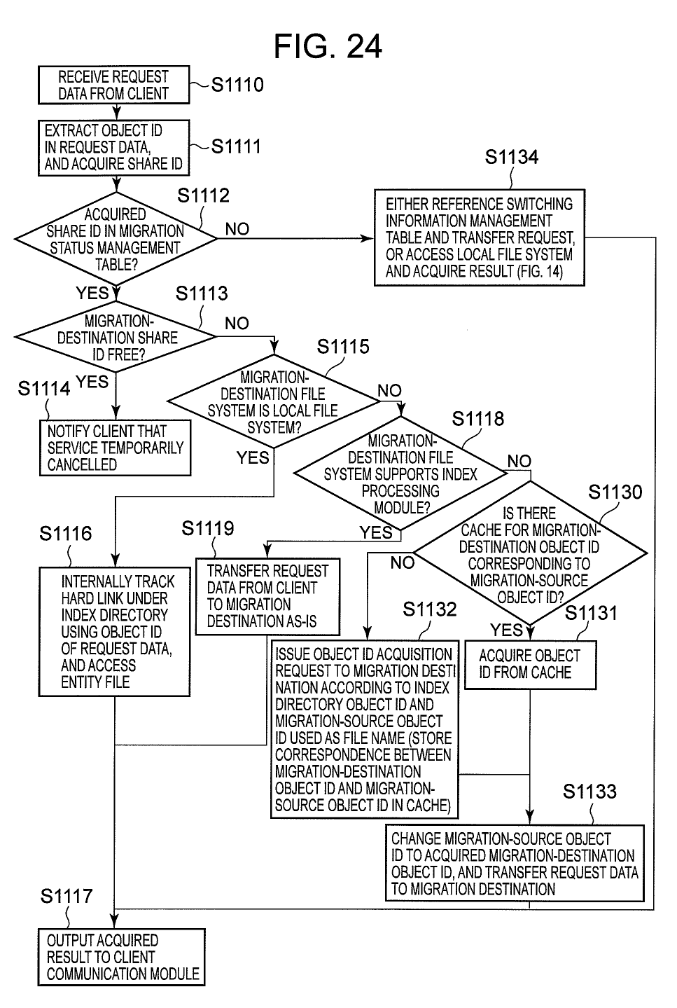

FIG. 24 is a flowchart of processing executed by the root node 200, which receives request data from the client 100 in the second embodiment.

The difference with the processing procedures in the first embodiment is steps S1130 through S1133, which are executed when the migration-destination file system 500 does not correspond with the index processing module 602.

In this case, in S1130, the index processing module 602 determines whether or not a migration-destination object ID corresponding to the migration-source object ID comprised in request data from the client 100 is stored in the object ID cache 607 (whether or not there is a cache). When there is a cache, processing moves to S1131, and when there is not a cache, processing moves to S1132.

In S1131, the index processing module 602 acquires the migration-destination object ID from the object ID cache 607.

In S1132, the index processing module 602, using the object ID 9304 of the index directory 504 and the object ID extracted in S1121 the same as in the first embodiment, issues a request to acquire the object ID of the hard link 505, which is in the index directory 504, and which has the object ID extracted in S1121 as its file name. The index processing module 602 stores the corresponding relationship between the acquired object ID (migration-destination object ID) and the above-mentioned extracted object ID (migration-source object ID) in the object ID cache 607. Consequently, thereafter, when request data comprises this migration-source object ID, the migration-destination object ID corresponding to this migration-source object ID can be acquired from the object ID cache 607.

Since the result obtained via the request of S1132 is the post-data migration processing object ID of a desired file, the file access manager 700 changes the object ID in the request data from the client 100 (migration-source object ID) to the post-data migration processing object ID (migration-destination object ID), and transfers the request data (file access request) to either migration-destination node 200 or 300.

According to the second embodiment above, when S1118 is NO, if there is a migration-destination object ID corresponding to the migration-source object ID in the received request data in the object ID cache 607, there is no need to query either migration-destination node 200 or 300 about a migration-destination object ID. Thus, it should be possible to return a response to the client 100 more rapidly than in the first embodiment.

### Third Embodiment

A third embodiment of the present invention will be explained next.

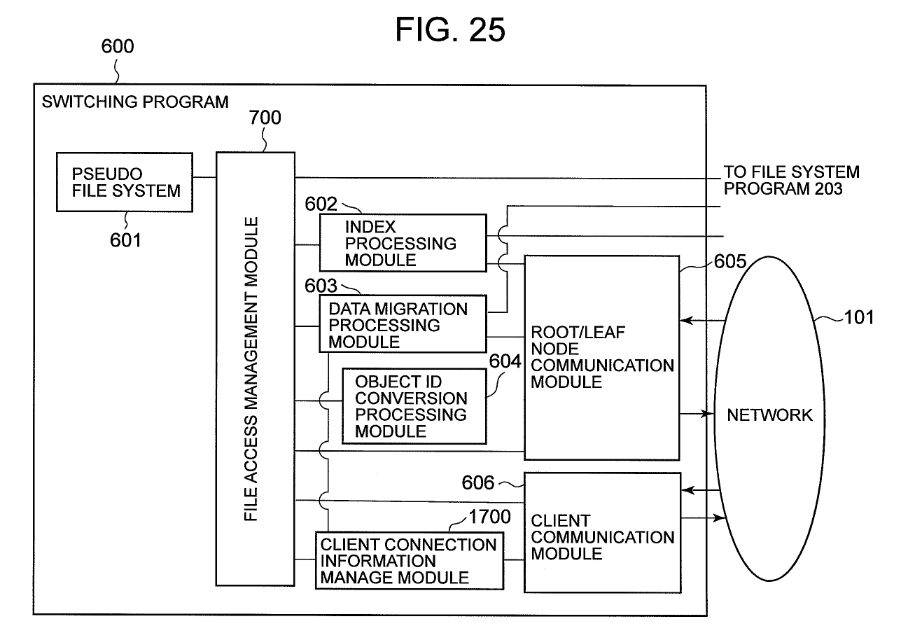

In a root node 200 of the third embodiment, the switching program 600 further comprises a client connection information manager 1700 as shown in FIG. 25.

The client connection information manager 1700 manages whether or not a connection for the client 100 to communicate with the root node 200 is established. For example, when the file sharing protocol is NFS, an operation in which the client 100 mounts the file system 207 of the root node 200 corresponds to establishing a connection, and an operation in which the client 100 unmounts the file system 207 of the root node 200 corresponds to closing the connection.

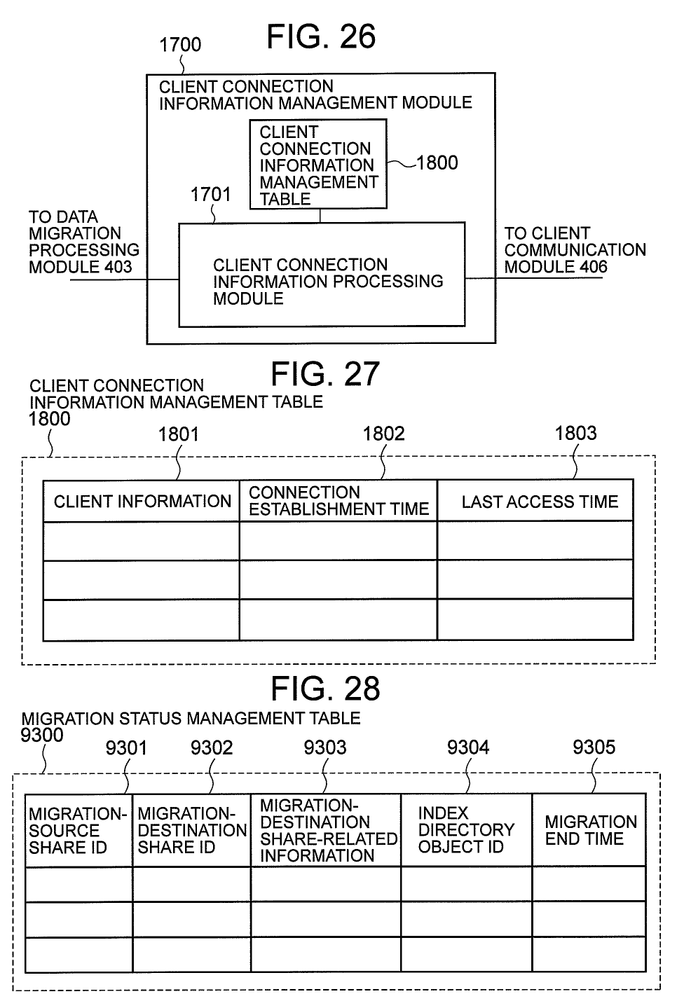

FIG. 26 is a block diagram showing an example of the constitution of the client connection information manager 1700.

The client connection information manager 1700 has a client connection information processing module 1701, and comprises a function for referencing a client connection information management table 1800.

FIG. 27 is a diagram showing an example of the constitution of the client connection information management table 1800.

The client connection information management table 1800 is a table, which has an entry constituted by a group comprising client information 1801; a connection establishment time 1802; and a last access time 1803. Client information 1801 is information related to a client 100, and, for example, is an IP address or socket structure. Connection establishment time 1802 is information showing the time at which a client 100 established a connection with a root node 200. The last access time 1803 is information showing the time of the last request from a client 100.

FIG. 28 is a diagram showing an example of the constitution of the migration status management table 9300 of the third embodiment.

An entry in the migration status management table 9300 further comprises migration end time 9305. The migration end time 9305 is information showing the time at which data migration processing ended.

The operation of a root node 200 in the third embodiment will be explained next.

In a root node 200, when the data migration processing module 603 references the client connection information management table 1800, and identifies the fact that there is no client 100 using the migration-source object ID, and that a prescribed period of time has elapsed since the last access by a client 100, the data migration processing module 603 deletes the entry of the migration status management table 9300, and the index directory tree corresponding to this entry.

First, the processing of the client connection information manager 1700 in the third embodiment will be explained. The client connection information manager 1700 adds an entry corresponding to a client 100 to the client connection information management table 1800 when this client 100 establishes a connection with the root node 200, and deletes this added entry from the client connection information management table 1800 when the client 100 closes the connection with the root node 200. Subsequent to a connection being established with the client 100, the client connection information processing module 1701 updates the last access time 1803 of the relevant entry in the client connection information management table 1800 upon receiving a request from the client communication module 606. This last access time 1803 does not have to be so strict that it is updated every time there is an access from a client 100; ascertaining whether or not there has been an access, and executing update each prescribed period of time is sufficient.

The procedures of data migration processing in the third embodiment will be explained next.

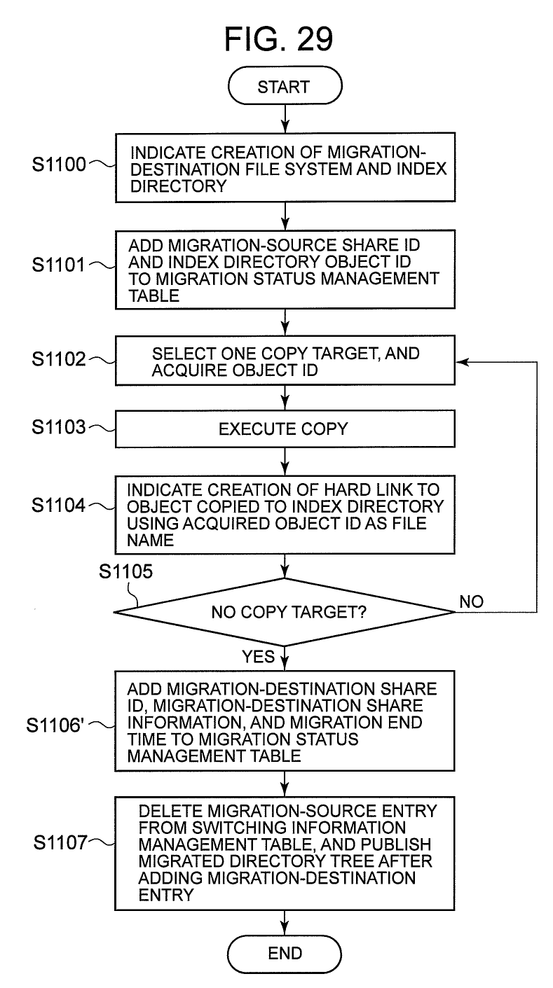

FIG. 29 is a flowchart of data migration processing in the third embodiment.

The difference with the procedures for data migration processing in the first embodiment is S1106′. In S1106′, when the data migration processing module 603 adds the migration-destination share ID 9302 and the migration-destination share-related information 9303 to the migration status management table 9300 at the end of a migration, the data migration processing module 603 also adds the migration end time 9305.

Next, the process for deleting an entry in the migration status management table 9300 and the index directory tree corresponding to this entry (hereinafter, called the “entry/index deletion process”) will be explained in detail.

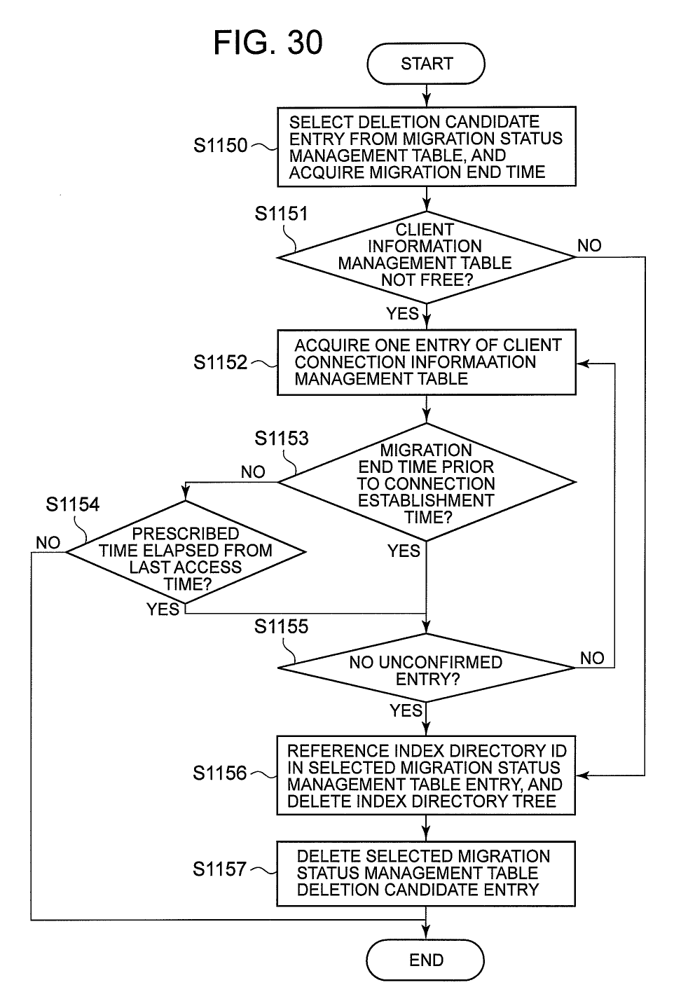

FIG. 30 is a flowchart of entry/index deletion processing.

In S1150, the data migration processing module 603 selects a deletion candidate entry from the migration status management table 9300 of the file access manager 700, and acquires the migration end time 9305. The deletion candidate entry, for example, can be an entry arbitrarily selected from the migration status management table 9300, or it can be an entry specified from the setting device (for example, the management computer).

In S1151, the data migration processing module 603 determines whether or not the client connection information management table 1800 of the client connection information manager 1700 is free. If the client connection information management table 1800 is free, processing moves to S1152, and if it is not, processing moves to S1156.

In S1152, the data migration processing module 603 selects and acquires one entry from the client connection information management table 1800.

In S1153, the data migration processing module 603 determines whether or not the time shown by the migration end time 9305 acquired in S1150 is prior to the time shown by the connection establishment time 1802 of the entry acquired in S1152. If this migration end time 9305 is prior to the connection establishment time 1802, processing moves to S1155, and if not, processing moves to S1154.

In S1155, the data migration processing module 603 determines whether or not an entry, which was not targeted for selection in S1152 (an unconfirmed entry), exists in the client connection information management table 1800. If such an entry does not exist, processing moves to S1156, and if such an entry exists, processing returns to S1152.

In S1156, the data migration processing module 603 references the index directory object ID 9304 in the S1150-selected entry of the migration status management table 9300, and sends to either migration-destination node 200 or 300 an indication (index delete indication) for deleting the index directory 504 identified from this object ID 9304 and the hard link 505 therebelow. Here, either migration-destination node 200 or 300 is a device, which specifies an entry having a share ID 801 that coincides with the migration-destination share ID 9302 in this entry, and specifies the server information 902 in an entry having a server information ID 901 that coincides with the server information ID 802 of this entry, and which is denoted by this server information 902. Either file system program 203 or 303 of either migration-destination node 200 or 300 deletes the index directory 504 and the hard link 505 therebelow (that is, the index directory tree 503) in accordance with the above-mentioned index delete indication.

In S1157, the data migration processing module 603 deletes from the migration status management table 9300 the S1150-selected deletion candidate entry of this table 9300.

In S1154, the data migration processing module 603 determines whether or not the present time is an elapsed prescribed time from the time shown by the last access time 1803 in the entry acquired in S1152. This prescribed time can be a time set by an administrator, or it can be a predetermined time. If the determination is that the prescribed time has elapsed, processing moves to S1155, and if the determination is that the prescribed time has not elapsed, processing ends.

Progressing to S1156 explained hereinabove means that either there is absolutely no client 100 using the migration-source object ID of the file system 207, which is managed by the root node 200 executing this entry/index delete processing, or, even if such a client 100 exists, there is little likelihood of the client 100 using the migration-source object ID because the present time is an elapsed prescribed time from the time shown by the last access time 1803. Thus, the data migration processing module 603 can delete from the migration status management table 9300 an entry related to a share unit of the migration source in this file system 207, and can delete the index directory tree 503 corresponding to this entry. This entry/index delete processing, for example, is executed by an administrator furnishing an indication to the data migration processing module 603, or by the data migration processing module 603 regularly executing this processing.

A number of embodiments of the present invention are explained hereinabove, but these embodiments are merely examples for explaining the present invention, and do not purport to limit the scope of the present invention solely to these embodiments. The present invention can be put into practice in a variety of other modes. For example, at least one of the first through the third embodiments can also be applied to the replacement of a file server (for example, a NAS (Network Attached Storage) device), which is not the target of management using a share ID. In this case, since a file server must respond to a client 100 with a migration-source object ID instead of a migration-destination object ID, a migration-source object ID can be stored in the attributes of the respective objects of a migrated directory tree (for example, a migration-source object ID can be registered in a prescribed location in a migration-destination object (file) corresponding to a hard link 505), and when there is an object ID acquisition request from the client 100, the migration-source object ID can be acquired from the attribute of a desired object and a response made subsequent to the index processing module 602 tracking a hard link 505 within the index directory 504.

What is claimed is:

1. A data migration processing device, comprising:
a migration target migration module that migrates a migration target comprising one or more objects to a migration-destination file server, which is a file server specified as a migration destination; and
a correspondence management indication module that sends to the migration-destination file server a correspondence management indication for creating object correspondence management information, which is information showing corresponding relationship between a migration-source object ID for identifying in a migration source an object included in the migration target, and a migration-destination object ID for identifying the object in this migration-destination file server.

2. The data migration processing device according to claim 1, wherein
the migration target in the migration-destination file server is a first directory tree denoting hierarchical relationship of a plurality of objects;
the object correspondence management information in the migration-destination file server is a second directory tree having a plurality of link files, which are respectively associated to the plurality of objects in the first directory tree; and
each file name of the plurality of link files is a migration-source object ID for an object corresponding to this link file.

3. The data migration processing device according to claim 1, further comprising:
a migration management module that registers, in migration management information, migration target information denoting the migration target and migration-destination information showing the migration-destination file server;
a request data receiving module that receives request data having a migration-source object ID; and
a request transfer processing module that specifies, from the migration management information, migration-destination information corresponding to the migration-source object ID using information in this migration-source object ID, and transferring request data having the migration-source object ID to a migration-destination file server denoted by the specified migration-destination information.

4. The data migration processing device according to claim 3, wherein, when specified, based on the specified migration-destination information, that a migration-destination file server, which is specified from this migration-destination information, does not have an index processing function for analyzing the object correspondence management information and for specifying a migration-destination object ID corresponding to the migration-source object ID, the request transfer processing module issues to this migration-destination file server a query for a migration-destination object ID corresponding to a migration-source object ID, and transfers, to the migration-destination file server, request data having in place of the migration-source object ID a migration-destination object ID obtained from a response receiving from the migration-destination file server, in response to the query.

5. The data migration processing device according to claim 1, further comprising:
a migration management module that registers, in migration management information, migration target information showing the migration target, and migration-destination information denoting the migration-destination file server;
a request data receiving module that receives request data having a migration-source object ID; and
a request transfer processing module, which specifies, from the migration management information, migration-destination information corresponding to this migration-source object ID using information in the migration-source object ID, issues to the migration-destination file server designated by the specified migration-destination information a query for a migration-destination object ID corresponding to the migration-source object ID, and transfers, to the migration-destination file server, request data having in place of the migration-source object ID a migration-destination object ID obtained from the migration-destination file server in response to the query.

6. The data migration processing device according to claim 5, wherein, when the migration-source object ID used in the query is associated, in a cache area, with a migration-destination object ID obtained in response to this query and the request data receiving module receives request data, and if a migration-destination object ID corresponding to the migration-source object ID in this request data is detected in the cache area, the request transfer processing module transfers to the migration-destination file server request data, which has the migration-destination object ID in place of this migration-source object ID.

7. The data migration processing device according to claim 1, further comprising a delete indication module that indicates to the migration-destination file server a delete indication for deleting the object correspondence management information when a migration-source object ID is not used for an object of the migration target.

8. The data migration processing device according to claim 7, wherein a migration-source object ID is not used for an object of the migration target when detection is made that the migration target has been unmounted from all clients.

9. The data migration processing device according to claim 1, further comprising a delete indication module that indicates to the migration-destination file server a delete indication for deleting the object correspondence management information when there has been no access from the client after passage of a prescribed period of time since completion of the migration of the migration target.

10. The data migration processing device according to claim 1, further comprising:
a request data receiving module that receives request data having a migration-source object ID;
a determination module, which makes a determination as to whether or not an object corresponding to a migration-source object ID of this request data is an object of the migration target, and whether this migration target is in process of being migrated; and
a response processing module, which, if a result of the determination is affirmative, creates response data showing that it is not possible to access an object corresponding to the migration-source object ID, and sends this response data to the source of this request data.

11. The data migration processing device according to claim 1, wherein
a share unit, which is a logical public unit, and which denotes hierarchical relationship of a plurality of objects, is a first directory tree;
the object correspondence management information in the migration-destination file server is a second directory tree having a plurality of link files, which are respectively associated with the plurality of objects in the first directory tree;
the correspondence management indication module indicates creation of a specified directory in a specified location of a file system managed by the migration-destination file server, acquires the migration-source object ID of an object in the share unit, and indicates the positioning of a link file, which has the migration-source object ID as a file name, under the specified directory; and
the second directory tree is a directory tree, which has the specified directory as a top directory.

12. The data migration processing device according to claim 11, further comprising:
a migration management module that registers, in migration management information, share information designating a share unit, which is the migration target, and migration-destination information denoting the migration-destination file server;
a request data receiving module that receives request data having a migration-source object ID comprising the share information; and
a request transfer processing module that specifies, from the migration management information, migration-destination information corresponding to share information in the migration-source object ID, and transferring request data having the migration-source object ID to the migration-destination file server denoted by the specified migration-destination information.

13. The data migration processing device according to claim 12, wherein
the migration management module, in addition to the share information and the migration-destination information, includes in the migration management information a directory object ID, which is an object ID corresponding to the specified directory, which is the top directory of the second directory tree; and
the request transfer processing module, when specified, based on the specified migration-destination information, that the migration-destination file server, which is specified from this migration-destination information, does not have an index processing function for specifying a migration-destination object ID corresponding to this migration-source object ID by tracking the second directory tree using the migration-source object ID, uses this migration-source object ID and a directory object ID corresponding to the migration-destination information to issue to this migration-destination file server a query for a migration-destination object ID corresponding to this migration-source object ID, and transfers, to the migration-destination file server, request data having in place of the migration-source object ID a migration-destination object ID obtained from the migration-destination file server, in response to the query.

14. The data migration processing device according to claim 11, further comprising:
a virtualization module that provides to one or more clients as a single virtual file system a plurality of share units, which comprise share units treated as the migration target; and
a delete indication module that indicates to the migration-destination file server a delete indication for deleting the object correspondence management information when the virtual file system is unmounted from all clients using this virtual file system.

15. A file server of a migration destination, which receives migration of a migration target comprising one or more objects, the file server comprising:
a correspondence management creation module that creates object correspondence management information, which is information showing the corresponding relationship between a migration-source object ID for identifying in the migration source an object included in a migration target, and a migration-destination object ID for identifying this object in itself;
a migration-destination object ID specification module that receives request data comprising a migration-source object ID, and specifying a migration-destination object ID corresponding to this migration-source object ID by analyzing the object correspondence management information; and
a request data processing module that executes an operation in accordance with the request data in respect of an object identified from the migration-destination object ID.

16. A file server system for providing file services to a client, comprising:
a first file server; and
a second file server,
the first file server comprising:
a migration target migration module that migrates a migration target comprising one or more objects to the second file server as a migration destination; and
a correspondence management indication module that sends to the second file server a correspondence management indication for creating object correspondence management information, which is information showing corresponding relationship between a migration-source object ID for identifying in the first file server of a migration source an object included in the migration target, and a migration-destination object ID for identifying this object in the second file server, and
the second file server comprising:
a correspondence management creation module that creates the object correspondence management information in response to the correspondence management indication;
a migration-destination object ID specification module that receives request data comprising a migration-source object ID, and specifying a migration-destination object ID corresponding to this migration-source object ID by analyzing the object correspondence management information; and
a request data processing module that executes an operation in accordance with the request data in respect of an object identified from the migration-destination object ID.

17. The file server system according to claim 16, wherein, in the second file server, the migration-destination object ID specification module receives from a client request data comprising a migration-source object ID, and specifies a migration-destination object ID corresponding to this migration-source object ID by analyzing the object correspondence management information, and the request data processing module returns a result of the operation execution to the client.

18. The file server system according to claim 16, wherein
the first file server further comprising:
a migration management module that registers, in migration management information, migration target information showing the migration target, and migration-destination information denoting the migration-destination file server;
a request data receiving module that receives from the client request data having a migration-source object ID;
a request transfer processing module that specifies, from the migration management information, migration-destination information corresponding to the migration-source object ID using information in this migration-source object ID, and for transferring request data having the migration-source object ID to the second file server denoted by the specified migration-destination information; and
a response module that returns to the client an operation execution result from the second file server, wherein
the request data processing module of the second file server returns to the first file server the operation execution result in accordance with the transferred request data.

19. The file server system according to claim 16, wherein
the first file server further comprising:
a migration management module that registers, in migration management information, migration target information showing the migration target, and migration-destination information denoting the migration-destination file server;
a request data receiving module that receives from the client request data having a migration-source object ID;
a request transfer processing module that specifies, from the migration management information, migration-destination information corresponding to the migration-source object ID using information in this migration-source object ID, issuing a query for a migration-destination object ID corresponding to the migration-source object ID to the second file server designated by the specified migration-destination information, and transferring, to the second file server, request data having in place of the migration-source object ID a migration-destination object ID obtained from the migration-destination file server; and
a response module that returns to the client an operation execution result received from the second file server, and wherein
the second file server further comprises a migration-destination object ID response module for responding to the first file server with a migration-destination object ID corresponding to this migration-source object ID in response to the query, and the request data processing module executes an operation in accordance with the request data in respect of an object identified from a migration-destination object ID in the transferred request data, and returns to the first file sever the execution result of this operation.

20. A data migration processing method comprising the steps of:
migrating a migration target comprising one or more objects to a migration-destination file server specified as a migration destination; and
creating in the migration-destination file server a correspondence management indication for creating object correspondence management information, which is information showing corresponding relationship between a migration-source object ID for identifying in a migration source an object included in the migration target, and a migration-destination object ID for identifying this object in the migration-destination file server.

21. The data migration processing method according to claim 20, wherein, when a migration-destination file server receives request data having a migration-source object ID, the migration-destination file server specifies a migration-destination object ID corresponding to the migration-source object ID of this request data by analyzing the object correspondence management information, executes an operation in accordance with this request data for an object identified from the specified migration-source object ID, and returns an execution result of this operation to the client from the migration-destination file server.

22. The data migration processing method according to claim 20, wherein, when a migration-source file server receives request data having a migration-source object ID, this request data is transferred from the migration-source file server to a migration-destination file server, the migration-destination file server specifies a migration-destination object ID corresponding to the migration-source object ID of this request data by analyzing the object correspondence management information, executes an operation in accordance with this request data for an object identified from the specified migration-source object ID, and returns the execution result of this operation to the client from the migration-destination file server via the migration-source file server.

23. The data migration processing method according to claim 20, wherein, when a migration-source file server receives request data having a migration-source object ID, a query for a migration-destination object ID corresponding to the migration-source object ID is issued to the migration-destination file server, the migration-destination file server replies with a migration-destination object ID corresponding to this migration-source object ID in response to this query, the migration-destination file server transfers the request data having in place of the migration-source object ID the replied migration-destination object ID to the migration-destination file server, the migration-destination file server executes an operation in accordance with this request data for an object identified from the migration-destination object ID of this request data, and returns the execution result of this operation to the client from the migration-destination file server via the migration-source file server.

24. The data migration processing device according to claim 1, wherein the migration target migration module includes a corresponding migration-source object ID in each of the one or more objects to be migrated.
